(19) United States
(12) Patent Application Publication
(10) Pub. No.: US 2025/0246008 A1
(43) Pub. Date: Jul. 31, 2025

(54) IMAGING SYSTEMS AND METHODS USEFUL FOR SPARSE SIGNAL EXTRACTION

(71) Applicant: Singular Genomics Systems, Inc., San Diego, CA (US)

(72) Inventor: Walter Pupin Fu, San Diego, CA (US)

(21) Appl. No.: 19/027,733

(22) Filed: Jan. 17, 2025

Related U.S. Application Data
(60) Provisional application No. 63/625,001, filed on Jan. 25, 2024.

(51) Int. Cl. G06V 20/69; G06T 7/33; G06V 10/28; G06V 10/50; G06V 10/98

(52) U.S. Cl. CPC G06V 20/695; G06T 7/337; G06V 10/28; G06V 10/507; G06V 10/98; G06V 20/693; G06T 2207/10056; G06T 2207/10064; G06T 2207/30024; G06T 2207/30072; G06V 2201/03

(57) ABSTRACT

Disclosed herein, inter alia, are methods and systems of image analysis useful for identifying and/or quantifying features associated with biomolecules.

### CROSS-REFERENCES TO RELATED APPLICATIONS

This application claims the benefit of U.S. Provisional Application No. 63/625,001, filed Jan. 25, 2024, which is incorporated herein by reference in its entirety and for all purposes.

### BACKGROUND

Next generation sequencing (NGS) methods typically rely on the detection of genomic fragments immobilized on an array. For example, in sequencing-by-synthesis (SBS), fluorescently labeled nucleotides are added to an array of polynucleotide primers and are detected upon incorporation. The extension of the nucleic acid primer along a nucleic acid template is monitored to determine the sequence of nucleotides in the template. Each detection event, (i.e., a feature), can be distinguished due to their location in the array.

For these and other applications of polynucleotide arrays, improvements have recently been made to increase density of features in the arrays. Technological advances reduced the typical distance between neighboring features such that the features are only slightly larger than the optical resolution scale, the pixel pitch of the camera, or both. Often, there is significant spatial overlap of fluorescent signal between neighboring features that needs to be considered by the image analysis algorithm. As the size of the features decreases and the overall size of the arrays expand, accurate detection becomes problematic.

### BRIEF SUMMARY

Disclosed herein, inter alia, are solutions to the aforementioned and other problems in the art. This disclosure provides methods and systems of image analysis useful for identifying and/or quantifying features not confined to regular patterns. The systems and methods can be used, for example, to register multiple images of features. In a non-limiting example, the systems and methods are configured to register multiple images of patterns that result from images derived from nucleic acid sequencing.

Also provided is a system that includes a processor; a storage device; and a program including instructions for carrying out or otherwise performing the steps of the above method.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIGS. 1A-1C. A representative ROI of the source image (FIG. 1) overlaid with the fitted grid. FIG. 1B presents the same data as in FIG. 1A, but Fourier up-sampled to better visualize the fit. FIG. 1C provides a histogram of the position errors between the mapped and simulated features across a number of these tests.

FIG. 2. Grid mapping accuracy as a function of feature occupancy fraction for a grid with a pitch of 4.48 pixels.

FIG. 3A-3B. Grid mapping accuracy as a function of feature occupancy fraction for grids of 3.2 pixels (FIG. 3A) and 2.24 pixels (FIG. 3B).

FIGS. 4A-4B. Local grid displacements in the Y-direction measured from an experimental dataset of eleven images, as a function of linescan position is shown in FIG. 4A. The individual acquisitions results are shown by the thin lines, while the average result is shown by the thick black line. FIG. 4B presents a Fourier power spectra of the data in FIG. 4A, showing the total spectral content as well as the breakdown by coherence (see Example 3).

FIG. 5 depicts an example system that may execute techniques and methods presented herein.

### DETAILED DESCRIPTION

### I. Definitions

The practice of the technology described herein will employ, unless indicated specifically to the contrary, conventional methods of chemistry, biochemistry, organic chemistry, molecular biology, microbiology, recombinant DNA techniques, genetics, immunology, and cell biology that are within the skill of the art, many of which are described below for the purpose of illustration. Examples of such techniques are available in the literature. See, e.g., Singleton et al., DICTIONARY OF MICROBIOLOGY AND MOLECULAR BIOLOGY 2nd ed., J. Wiley & Sons (New York, NY 1994); and Sambrook and Green, Molecular Cloning: A Laboratory Manual, 4th Edition (2012). Methods, devices and materials similar or equivalent to those described herein can be used in the practice of this invention.

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise.

Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

As used herein, the term “associated” or “associated with” can mean that two or more species are identifiable as being co-located at a point in time. An association can mean that two or more species are or were within a similar container. An association can be an informatics association, where for example digital information regarding two or more species is stored and can be used to determine that one or more of the species were co-located at a point in time. An association can also be a physical association. In some instances two or more associated species are “tethered”, “coated”, “attached”, or “immobilized” to one another or to a common solid or semisolid support. An association may refer to covalent or non-covalent means for attaching labels to solid or semi-solid supports such as beads. In embodiments, primers on or bound to a solid support are covalently attached to the solid support. An association may comprise hybridization between a target and a label.

As used herein, the term “hybridize” or “specifically hybridize” refers to a process where two complementary nucleic acid strands anneal to each other under appropriately stringent conditions. Hybridizations are typically and preferably conducted with oligonucleotides. The terms “annealing” and “hybridization” are used interchangeably to mean the formation of a stable duplex. Non-limiting examples of nucleic acid hybridization techniques are described in, for example, Sambrook, et al., Molecular Cloning: A Laboratory Manual (2nd Edition, 1989).

As used herein, the term “nucleic acid” refers to nucleotides (e.g., deoxyribonucleotides or ribonucleotides) and polymers thereof in either single-, double- or multiple-stranded form, or complements thereof. The terms “polynucleotide,” “oligonucleotide,” “oligo” or the like refer, in the usual and customary sense, to a sequence of nucleotides. The term “nucleotide” refers, in the usual and customary sense, to a single unit of a polynucleotide, i.e., a monomer. Nucleotides can be ribonucleotides, deoxyribonucleotides, or modified versions thereof. Examples of polynucleotides contemplated herein include single and double stranded DNA, single and double stranded RNA, and hybrid molecules having mixtures of single and double stranded DNA and RNA with linear or circular framework. Non-limiting examples of polynucleotides include a gene, a gene fragment, an exon, an intron, intergenic DNA (including, without limitation, heterochromatic DNA), messenger RNA (mRNA), transfer RNA, ribosomal RNA, a ribozyme, cDNA, a recombinant polynucleotide, a branched polynucleotide, a plasmid, a vector, isolated DNA of a sequence, isolated RNA of a sequence, a nucleic acid probe, and a primer. Polynucleotides useful in the methods of the disclosure may comprise natural nucleic acid sequences and variants thereof, artificial nucleic acid sequences, or a combination of such sequences.

As used herein, the terms “polynucleotide primer” and “primer” refers to any polynucleotide molecule that may hybridize to a polynucleotide template, be bound by a polymerase, and be extended in a template-directed process for nucleic acid synthesis. The primer may be a separate polynucleotide from the polynucleotide template, or both may be portions of the same polynucleotide (e.g., as in a hairpin structure having a 3′ end that is extended along another portion of the polynucleotide to extend a double-stranded portion of the hairpin). Primers (e.g., forward or reverse primers) may be attached to a solid support. A primer can be of any length depending on the particular technique it will be used for. For example, PCR primers are generally between 10 and 40 nucleotides in length. The length and complexity of the nucleic acid fixed onto the nucleic acid template may vary. One of skill can adjust these factors to provide optimum hybridization and signal production for a given hybridization procedure. The primer permits the addition of a nucleotide residue thereto, or oligonucleotide or polynucleotide synthesis therefrom, under suitable conditions. In an embodiment the primer is a DNA primer, i.e., a primer consisting of, or largely consisting of, deoxyribonucleotide residues.

As used herein, the term “template polynucleotide” refers to any polynucleotide molecule that may be bound by a polymerase and utilized as a template for nucleic acid synthesis. A template polynucleotide may be a target polynucleotide. In general, the term “target polynucleotide” refers to a nucleic acid molecule or polynucleotide in a starting population of nucleic acid molecules having a target sequence whose presence, amount, and/or nucleotide sequence, or changes in one or more of these, are desired to be determined. In general, the term “target sequence” refers to a nucleic acid sequence on a single strand of nucleic acid. The target sequence may be a portion of a gene, a regulatory sequence, genomic DNA, cDNA, RNA including mRNA, miRNA, rRNA, or others.

A polynucleotide is typically composed of a specific sequence of four nucleotide bases: adenine (A); cytosine (C); guanine (G); and thymine (T) (uracil (U) for thymine (T) when the polynucleotide is RNA). Thus, the term “polynucleotide sequence” is the alphabetical representation of a polynucleotide molecule; alternatively, the term may be applied to the polynucleotide molecule itself. This alphabetical representation can be input into databases in a computer having a central processing unit and used for bioinformatics applications such as functional genomics and homology searching. Polynucleotides may optionally include one or more non-standard nucleotide(s), nucleotide analog(s) and/or modified nucleotides.

As used herein, the term “modified nucleotide” refers to nucleotide modified in some manner. Typically, a nucleotide contains a single 5-carbon sugar moiety, a single nitrogenous base moiety and 1 to three phosphate moieties. In embodiments, a nucleotide can include a blocking moiety or a label moiety. A blocking moiety on a nucleotide prevents formation of a covalent bond between the 3′ hydroxyl moiety of the nucleotide and the 5′ phosphate of another nucleotide. A blocking moiety on a nucleotide can be reversible, whereby the blocking moiety can be removed or modified to allow the 3′ hydroxyl to form a covalent bond with the 5′ phosphate of another nucleotide. A blocking moiety can be effectively irreversible under particular conditions used in a method set forth herein. A label moiety of a nucleotide can be any moiety that allows the nucleotide to be detected, for example, using a spectroscopic method. Exemplary label moieties are fluorescent labels, mass labels, chemiluminescent labels, electrochemical labels, detectable labels and the like. One or more of the above moieties can be absent from a nucleotide used in the methods and compositions set forth herein. For example, a nucleotide can lack a label moiety or a blocking moiety or both.

As used herein, the term “label” or “labels” generally refer to molecules that can directly or indirectly produce or result in a detectable signal either by themselves or upon interaction with another molecule. Non-limiting examples of detectable labels include labels comprising fluorescent dyes, biotin, digoxin, haptens, and epitopes. In general, a dye is a molecule, compound, or substance that can provide an optically detectable signal, such as a colorimetric, luminescent, bioluminescent, chemiluminescent, phosphorescent, or fluorescent signal. In embodiments, the dye is a fluorescent dye. Non-limiting examples of dyes, some of which are commercially available, include CF dyes (Biotium, Inc.), Alexa Fluor dyes (Thermo Fisher), DyLight dyes (Thermo Fisher), Cy dyes (GE Healthscience), IRDyes (Li-Cor Biosciences, Inc.), and HiLyte dyes (Anaspec, Inc.).

As used herein, the terms “solid support” and “substrate” and “solid surface” refers to discrete solid or semi-solid surfaces to which a plurality of primers may be attached. A solid support may encompass any type of solid, porous, or hollow sphere, ball, cylinder, or other similar configuration composed of plastic, ceramic, metal, or polymeric material (e.g., hydrogel) onto which a nucleic acid may be immobilized (e.g., covalently or non-covalently). A solid support may comprise a discrete particle that may be spherical (e.g., microspheres) or have a non-spherical or irregular shape, such as cubic, cuboid, pyramidal, cylindrical, conical, oblong, or disc-shaped, and the like. A bead can be non-spherical in shape. A solid support may be used interchangeably with the term “bead.” A solid support may further comprise a polymer or hydrogel on the surface to which the primers are attached. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor, silica or silica-based materials including silicon and modified silicon, carbon, metals, inorganic glasses, optical fiber bundles, photopatternable dry film resists, UV-cured adhesives and polymers. Useful substrates include those that allow optical detection, for example, by being translucent to energy of a desired detection wavelength and/or do not produce appreciable background fluorescence at a particular detection wavelength. The solid supports for some embodiments have at least one surface located within a flow cell. The solid support, or regions thereof, can be substantially flat. The solid support can have surface features such as wells, pits, channels, ridges, raised regions, pegs, posts or the like. The term solid support is encompassing of a substrate (e.g., a flow cell) having a surface comprising a polymer coating covalently attached thereto. In embodiments, the solid support is a flow cell. The term “flowcell” as used herein refers to a chamber including a solid surface across which one or more fluid reagents can be flowed. Examples of flowcells and related fluidic systems and detection platforms that can be readily used in the methods of the present disclosure are described, for example, in Bentley et al., Nature 456:53-59 (2008).

The term “array” is used in accordance with its ordinary meaning in the art, and refers to a population of different molecules that are attached to one or more solid-phase substrates such that the different molecules can be differentiated from each other according to their relative location. An array can include different molecules that are each located at different addressable features on a solid-phase substrate. The molecules of the array can be nucleic acid primers, nucleic acid probes, nucleic acid templates or nucleic acid enzymes such as polymerases or ligases. Arrays useful in the invention can have densities that ranges from about 2 different features to many millions, billions or higher. The density of an array can be from 2 to as many as a billion or more different features per square cm. For example an array can have at least about 100 features/cm², at least about 1,000 features/cm², at least about 10,000 features/cm², at least about 100,000 features/cm², at least about 10,000,000 features/cm², at least about 100,000,000 features/cm², at least about 1,000,000,000 features/cm², at least about 2,000,000,000 features/cm² or higher. In embodiments, the arrays have features at any of a variety of densities including, for example, at least about 10 features/cm², 100 features/cm², 500 features/cm², 1,000 features/cm², 5,000 features/cm², 10,000 features/cm², 50,000 features/cm², 100,000 features/cm², 1,000,000 features/cm², 5,000,000 features/cm², or higher. In embodiments, the array is provided in a microplate. The term “microplate”, as used herein, refers to a substrate comprising a surface, the surface including a plurality of reaction chambers separated from each other by interstitial regions on the surface. In embodiments, the microplate has dimensions as provided and described by American National Standards Institute (ANSI) and Society for Laboratory Automation And Screening (SLAS); for example the tolerances and dimensions set forth in ANSI SLAS 1-2004 (R2012); ANSI SLAS 2-2004 (R2012); ANSI SLAS 3-2004 (R2012); ANSI SLAS 4-2004 (R2012); and ANSI SLAS 6-2012, which are incorporated herein by reference. The dimensions of the microplate as described herein and the arrangement of the reaction chambers may be compatible with an established format for automated laboratory equipment. The reaction chambers may be provided as wells (alternatively referred to as reaction chambers), for example a microplate may contain 6, 12, 24, 48, 96, 384, or 1536 sample wells arranged in a 2:3 rectangular matrix. In embodiments, the reaction chamber is a microscope slide (e.g., a glass slide about 75 mm by about 25 mm). In embodiments the slide is a concavity slide (e.g., the slide includes a depression). In embodiments, the slide includes a coating for enhanced cell adhesion (e.g., poly-L-lysine, silanes, carbon nanotubes, polymers, epoxy resins, or gold). In embodiments, the microplate is about 5 inches by 3.33 inches, and includes a plurality of 5 mm diameter wells. In embodiments, the microplate is a flat glass or plastic tray in which an array of wells are formed, wherein each well can hold between from a few microliters to hundreds of microliters of fluid reagents and samples. The term “well” refers to a discrete concave feature in a substrate having a surface opening that is completely surrounded by interstitial region(s) of the surface. Wells can have any of a variety of shapes at their opening in a surface including but not limited to round, elliptical, square, polygonal, or star shaped (i.e., star shaped with any number of vertices). The cross section of a well taken orthogonally with the surface may be curved, square, polygonal, hyperbolic, conical, or angular. The wells of a microplate are available in different shapes, for example F-Bottom: flat bottom; C-Bottom: bottom with minimal rounded edges; V-Bottom: V-shaped bottom; or U-Bottom: U-shaped bottom. In embodiments, the well is square.

As used herein, the terms “cluster” and “colony” are used interchangeably to refer to a discrete site on a solid support that includes a plurality of immobilized polynucleotides and a plurality of immobilized complementary polynucleotides. The term “clustered array” refers to an array formed from such clusters or colonies. In this context the term “array” is not to be understood as requiring an ordered arrangement of clusters.

As used herein, the term “selective” or “selectivity” or the like of a compound refers to the compound's ability to discriminate between molecular targets.

The terms “bind” and “bound” as used herein are used in accordance with their plain and ordinary meanings and refer to an association between atoms or molecules. The association can be direct or indirect. For example, bound atoms or molecules may be directly bound to one another, e.g., by a covalent bond or non-covalent bond (e.g. electrostatic interactions (e.g. ionic bond, hydrogen bond, halogen bond), van der Waals interactions (e.g. dipole-dipole, dipole-induced dipole, London dispersion), ring stacking (pi effects), hydrophobic interactions and the like). As a further example, two molecules may be bound indirectly to one another by way of direct binding to one or more intermediate molecules (e.g., as in a substrate, bound to a first antibody, bound to an analyte, bound to a second antibody), thereby forming a complex. As used herein, the term “attached” refers to the state of two things being joined, fastened, adhered, connected or bound to each other. For example, a nucleic acid, can be attached to a material, such as a hydrogel, polymer, or solid support, by a covalent or non-covalent bond. In embodiments, attachment is a covalent attachment.

Where a range of values is provided, it is understood that each intervening value, to the tenth of the unit of the lower limit unless the context clearly indicates otherwise, between the upper and lower limit of that range, and any other stated or unstated intervening value in, or smaller range of values within, that stated range is encompassed within the invention. The upper and lower limits of any such smaller range (within a more broadly recited range) may independently be included in the smaller ranges, or as particular values themselves, and are also encompassed within the invention, subject to any specifically excluded limit in the stated range. Where the stated range includes one or both of the limits, ranges excluding either or both of those included limits are also included in the invention.

The terms “sequencing”, “sequence determination”, “determining a nucleotide sequence”, and the like include determination of partial as well as full sequence information of the polynucleotide being sequenced. That is, the term includes sequence comparisons, fingerprinting, and like levels of information about a target polynucleotide, as well as the express identification and ordering of nucleotides in a target polynucleotide. The term also includes the determination of the identification, ordering, and locations of one, two, or three of the four types of nucleotides within a target polynucleotide. As used herein, the term “sequencing cycle” is used in accordance with its plain and ordinary meaning and refers to incorporating one or more nucleotides to the 3′ end of a polynucleotide with a polymerase, and detecting one or more labels that identify the one or more nucleotides incorporated. The sequencing may be accomplished by, for example, sequencing by synthesis, pyrosequencing, and the like. In embodiments, a sequencing cycle includes extending a complementary polynucleotide by incorporating a first nucleotide using a polymerase, wherein the polynucleotide is hybridized to a template nucleic acid, detecting the first nucleotide, and identifying the first nucleotide. In embodiments, to begin a sequencing cycle, one or more differently labeled nucleotides and a DNA polymerase can be introduced. Following nucleotide addition, signals produced (e.g., via excitation and emission of a detectable label) can be detected to determine the identity of the incorporated nucleotide (based on the labels on the nucleotides). Reagents can then be added to remove the 3′ reversible terminator and to remove labels from each incorporated base. Reagents, enzymes and other substances can be removed between steps by washing. Cycles may include repeating these steps, and the sequence of each cluster is read over the multiple repetitions.

As used herein, the term “feature” refers a point or area in a pattern that can be distinguished from other points or areas according to its relative location. An individual feature can include one or more polynucleotides. For example, a feature can include a single target nucleic acid molecule having a particular sequence or a feature can include several nucleic acid molecules having the same sequence (and/or complementary sequence, thereof). Different molecules that are at different features of a pattern can be differentiated from each other according to the locations of the features in the pattern. Non-limiting examples of features include wells in a substrate, particles (e.g., beads) in or on a substrate, polymers in or on a substrate, projections from a substrate, ridges on a substrate, or channels in a substrate. In embodiments, a feature refers to a location in an array where a particular species of molecule is present. A feature can contain only a single molecule or it can contain a population of several molecules of the same species. Features of an array are typically discrete. The discrete features can be contiguous or they can have spaces between each other. The size of the features and/or spacing between the features can vary such that arrays can be high density, medium density or lower density. High density arrays are characterized as having sites separated by less than about 15 μm (e.g., 3-6 μm). Medium density arrays have sites separated by about 15 to 30 μm. Low density arrays have sites separated by greater than 30 μm. An array useful herein can have, for example, sites that are separated by less than 10 μm, 5 μm, 1 μm, or 0.5 μm. An apparatus or method of the present disclosure can be used to detect an array at a resolution sufficient to distinguish sites at the above densities or density ranges. A feature can contain only a single molecule or it can contain a population of several molecules of the same species (i.e., a cluster). Features of an array are typically discrete. The discrete features can be contiguous, or they can have spaces between each other. An “optically resolvable feature” refers to a feature capable of being distinguished from other features. Optics and sensor resolution has a finite limit as to a resolvable area. The Rayleigh criterion for the diffraction limit to resolution states that two images are just resolvable when the center of the diffraction pattern of one object is directly over the first minimum of the diffraction pattern of the other object. The minimal distance between two resolvable objects, r, is proportional to the wavelength of light and inversely proportional to the numerical aperture (NA). That is, the minimal distance between two resolvable objects is provided as r=0.61 wavelength/NA. If detecting light in the UV-vis spectrum (about 100 nm to about 900 nm), the remaining mutable variable to increase the resolution is the NA of the objective lens. A lens with a large NA will be able to resolve finer details. For example, a lens with larger NA is capable of detecting more light and so it produces a brighter image. Thus, a large NA lens provides more information to form a clear image, and so its resolving power will be higher. Typical dry objectives have an NA of about 0.80 to about 0.95. Higher NAs may be obtained by increasing the imaging medium refractive index between the object and the objective front lens for example immersing the lens in water (refractive index=1.33), glycerin (refractive index=1.47), or immersion oil (refractive index=1.51). Most oil immersion objectives have a maximum numerical aperture of 1.4, with the typical objectives having an NA ranging from 1.0 to 1.35.

As used herein, the term “full width at half maximum” or “FWHM” refers the width of a maximum on a line curve or line function provided by the distance between the points on the line curve corresponding to where the function reaches its half maximum.

In embodiments, the features have a mean or median separation from one another of about 0.5-5 μm. In embodiments, the mean or median separation is about 0.1-10 microns, 0.25-5 microns, 0.5-2 microns, 1 micron, or a number or a range between any two of these values. In embodiments, the mean or median separation is about or at least about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4., 4.5, 4.6, 4.7, 4.8, 4.9, 5.0 μm or a number or a range between any two of these values. In embodiments, the mean or median separation is about 0.1-10 microns. In embodiments, the mean or median separation is about 0.25-5 microns. In embodiments, the mean or median separation is about 0.5-2 microns.

In embodiments, the features have a mean or median diameter of about 100-2000 nm, or about 200-1000 nm. In embodiments, the mean or median diameter is about 100-3000 nanometers, about 500-2500 nanometers, about 1000-2000 nanometers, or a number or a range between any two of these values. In embodiments, the mean or median diameter is about or at most about 100, 200, 300, 400, 500, 600, 700, 800, 900, 1000, 1100, 1200, 1300, 1400, 1500, 1600, 1700, 1800, 1900, 2000 nanometers or a number or a range between any two of these values.

The distances between features can be described in any number of ways. In some embodiments, the distances between features can be described from the center of one feature to the center of another feature. In other embodiments, the distances can be described from the edge of one feature to the edge of another feature, or between the outer-most identifiable points of each feature. The edge of a feature can be described as the theoretical or actual physical boundary on a chip, or some point inside the boundary of the feature. In other embodiments, the distances can be described in relation to a fixed point on the object or in the image of the object.

The term “pitch,” is used in accordance with its ordinary meaning when used in reference to features of an array, and refers to the spacing (e.g., center-to-center) for adjacent features. The term refers to spacing in the xy dimension. A pattern of features can be characterized in terms of average pitch. The pattern can be ordered such that the coefficient of variation around the average pitch is small or the pattern can be random in which case the coefficient of variation can be relatively large. In either case, the average pitch can be, for example, at least about 10 nm, about 0.1 μm, about 0.5 μm, about 1 μm, about 5 μm, about 10 μm, or more. In embodiments, the average pitch can be, about 10 μm, about 5 μm, about 1 μm, about 0.5 μm, about 0.1 μm or less. In embodiments, features are 450 nm in diameter with a pitch of 1.4 μm.

The term “image” is used according to its ordinary meaning and refers to a representation of all or part of an object. The representation may be an optically detected reproduction. For example, an image can be obtained from a detection apparatus configured to obtain fluorescent, luminescent, scatter, or absorption signals. The part of the object that is present in an image can be the surface or other xy plane of the object. Typically, an image is a 2 dimensional representation of a 3 dimensional object. An image may include signals at differing intensities (i.e., signal levels). An image can be provided in a computer readable format or medium.

As used herein, the term “signal” is intended to include, for example, fluorescent, luminescent, scatter, or absorption impulse or electromagnetic wave transmitted or received. Signals can be detected in the ultraviolet (UV) range (about 200 to 390 nm), visible (VIS) range (about 391 to 770 nm), infrared (IR) range (about 0.771 to 25 microns), or other range of the electromagnetic spectrum. The term “signal level” refers to an amount or quantity of detected energy or coded information. For example, a signal may be quantified by its intensity, wavelength, energy, frequency, power, luminance, or a combination thereof. Other signals can be quantified according to characteristics such as voltage, current, electric field strength, magnetic field strength, frequency, power, temperature, etc. Absence of signal is understood to be a signal level of zero or a signal level that is not meaningfully distinguished from noise.

The term “xy coordinates” refers to information that specifies location, size, shape, and/or orientation in an xy plane. The information can be, for example, numerical coordinates in a Cartesian system. The coordinates can be provided relative to one or both of the x and y axes or can be provided relative to another location in the xy plane (e.g., a fiducial). The term “xy plane” refers to a 2 dimensional area defined by straight line axes x and y. When used in reference to a detecting apparatus and an object observed by the detector, the xy plane may be specified as being orthogonal to the direction of observation between the detector and object being detected.

As used herein, the term “kit” refers to any delivery system for delivering materials. In the context of reaction assays, such delivery systems include systems that allow for the storage, transport, or delivery of reaction reagents (e.g., oligonucleotides, enzymes, etc. in the appropriate containers) and/or supporting materials (e.g., buffers, written instructions for performing the assay, etc.) from one location to another. For example, kits include one or more enclosures (e.g., boxes) containing the relevant reaction reagents and/or supporting materials. As used herein, the term “fragmented kit” refers to a delivery system including two or more separate containers that each contain a subportion of the total kit components. The containers may be delivered to the intended recipient together or separately. For example, a first container may contain an enzyme for use in an assay, while a second container contains oligonucleotides. In contrast, a “combined kit” refers to a delivery system containing all of the components of a reaction assay in a single container (e.g., in a single box housing each of the desired components). The term “kit” includes both fragmented and combined kits.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware and systems used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In embodiments, the functions of the systems described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The term “computing device” is used herein to refer to an electronic device equipped with at least a processor. Examples of computing devices may include system or device described herein, mobile devices (e.g., cellular telephones, wearable devices, smartphones, smartwatches, web-pads, tablet computers, Internet enabled cellular telephones, Wi-Fi® enabled electronic devices, personal data assistants (PDAs), laptop computers, etc.), personal computers, and server computing devices. In various embodiments, computing devices may be configured with memory and/or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® router, etc.). In embodiments, the computing device is a mobile device, such as a cellular telephone, wearable device, or smartphone (e.g., iphone, Android, Blackberry, Palm, Symbian, or Windows).

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Provided herein are methods, systems, and compositions for analyzing a sample (e.g., sequencing nucleic acids within a sample) in situ. The term “in situ” is used in accordance with its ordinary meaning in the art and refers to a sample surrounded by at least a portion of its native environment, such as may preserve the relative position of two or more elements. For example, an extracted human cell obtained is considered in situ when the cell is retained in its local microenvironment so as to avoid extracting the target (e.g., nucleic acid molecules or proteins) away from their native environment. An in situ sample (e.g., a cell) can be obtained from a suitable subject. An in situ cell sample may refer to a cell and its surrounding milieu, or a tissue. A sample can be isolated or obtained directly from a subject or part thereof. In embodiments, the methods described herein (e.g., sequencing a plurality of target nucleic acids of a cell in situ) are applied to an isolated cell (i.e., a cell not surrounded by least a portion of its native environment). For the avoidance of any doubt, when the method is performed within a cell (e.g., an isolated cell) the method may be considered in situ. In some embodiments, a sample is obtained indirectly from an individual or medical professional. A sample can be any specimen that is isolated or obtained from a subject or part thereof. A sample can be any specimen that is isolated or obtained from multiple subjects. Non-limiting examples of specimens include fluid or tissue from a subject, including, without limitation, blood or a blood product (e.g., serum, plasma, platelets, buffy coats, or the like), umbilical cord blood, chorionic villi, amniotic fluid, cerebrospinal fluid, spinal fluid, lavage fluid (e.g., lung, gastric, peritoneal, ductal, ear, arthroscopic), a biopsy sample, celocentesis sample, cells (blood cells, lymphocytes, placental cells, stem cells, bone marrow derived cells, embryo or fetal cells) or parts thereof (e.g., mitochondrial, nucleus, extracts, or the like), urine, feces, sputum, saliva, nasal mucous, prostate fluid, lavage, semen, lymphatic fluid, bile, tears, sweat, breast milk, breast fluid, the like or combinations thereof. Non-limiting examples of tissues include organ tissues (e.g., liver, kidney, lung, thymus, adrenals, skin, bladder, reproductive organs, intestine, colon, spleen, brain, the like or parts thereof), epithelial tissue, hair, hair follicles, ducts, canals, bone, eye, nose, mouth, throat, ear, nails, the like, parts thereof or combinations thereof. A sample may include cells or tissues that are normal, healthy, diseased (e.g., infected), and/or cancerous (e.g., cancer cells). A sample obtained from a subject may include cells or cellular material (e.g., nucleic acids) of multiple organisms (e.g., virus nucleic acid, fetal nucleic acid, bacterial nucleic acid, parasite nucleic acid). A sample may include a cell and RNA transcripts. A sample can include nucleic acids obtained from one or more subjects. In some embodiments a sample includes nucleic acid obtained from a single subject. A subject can be any living or non-living organism, including but not limited to a human, non-human animal, plant, bacterium, fungus, virus, or protist. A subject may be any age (e.g., an embryo, a fetus, infant, child, adult). A subject can be of any sex (e.g., male, female, or combination thereof). A subject may be pregnant. In some embodiments, a subject is a mammal. In some embodiments, a subject is a plant. In some embodiments, a subject is a human subject. A subject can be a patient (e.g., a human patient). In some embodiments a subject is suspected of having a genetic variation or a disease or condition associated with a genetic variation.

As used herein, the term “tissue” is used in accordance with its plain and ordinary meaning and refers to an organization of cells in a structure, where the structure generally functions as a unit in an organism (e.g., mammals) and may carry out specific functions. In some examples, cells in a tissue are configured in a mass and may not be free from one another. This disclosure describes methods of obtaining single biological samples (e.g., cells or nuclei) from tissues that can be used in various single biological samples (e.g., single-cell/nucleus) workflows. In some examples, blood cells (e.g., lymphocytes) can be considered a tissue. However, blood cells, like lymphocytes, generally are free from one another in the blood. The methods disclosed herein can be used to process those cells to obtain cells and/or nuclei, although dissociation steps may not be necessary when using those types of tissues. Generally, any type of tissue can be used in the methods described herein. Examples of tissues that may be used in the disclosed methods include, but are not limited to connective, epithelial, muscle and nervous tissue. In some examples, the tissues are from mammals. Tissues that contain any type of cells may be used. For example, tissues from abdomen, bladder, brain, esophagus, heart, intestine, kidney, liver, lung, lymph node, olfactory bulb, ovary, pancreas, skin, spleen, stomach, testicle, and the like. The tissue may be normal or tumor tissue (e.g., malignant). This example is not meant to be limiting. Although the conditions used in the disclosed may not be identical for different types of tissue, the methods may be applied to any tissue. The tissues used in the disclosed methods may be in various states. In some examples, the tissues used in the disclosed methods may be fresh, frozen, or fixed.

As used herein, the term “polymer” refers to macromolecules having one or more structurally unique repeating units. The repeating units are referred to as “monomers,” which are polymerized for the polymer. Typically, a polymer is formed by monomers linked in a chain-like structure. A polymer formed entirely from a single type of monomer is referred to as a “homopolymer.” A polymer formed from two or more unique repeating structural units may be referred to as a “copolymer.” A polymer may be linear or branched, and may be random, block, polymer brush, hyperbranched polymer, bottlebrush polymer, dendritic polymer, or polymer micelles. The term “polymer” includes homopolymers, copolymers, tripolymers, tetra polymers and other polymeric molecules made from monomeric subunits. Copolymers include alternating copolymers, periodic copolymers, statistical copolymers, random copolymers, block copolymers, linear copolymers and branched copolymers. The term “polymerizable monomer” is used in accordance with its meaning in the art of polymer chemistry and refers to a compound that may covalently bind chemically to other monomer molecules (such as other polymerizable monomers that are the same or different) to form a polymer. Polymers can be hydrophilic, hydrophobic or amphiphilic, as known in the art. Thus, “hydrophilic polymers” are substantially miscible with water and include, but are not limited to, polyethylene glycol and the like. “Hydrophobic polymers” are substantially immiscible with water and include, but are not limited to, polyethylene, polypropylene, polybutadiene, polystyrene, polymers disclosed herein, and the like. “Amphiphilic polymers” have both hydrophilic and hydrophobic properties and are typically copolymers having hydrophilic segment(s) and hydrophobic segment(s). Polymers include homopolymers, random copolymers, and block copolymers, as known in the art. The term “homopolymer” refers, in the usual and customary sense, to a polymer having a single monomeric unit. The term “copolymer” refers to a polymer derived from two or more monomeric species. The term “random copolymer” refers to a polymer derived from two or more monomeric species with no preferred ordering of the monomeric species. The term “block copolymer” refers to polymers having two or homopolymer subunits linked by covalent bond. Thus, the term “hydrophobic homopolymer” refers to a homopolymer which is hydrophobic. The term “hydrophobic block copolymer” refers to two or more homopolymer subunits linked by covalent bonds and which is hydrophobic.

As used herein, the term “substrate” refers to a solid support material. The substrate can be non-porous or porous. The substrate can be rigid or flexible. As used herein, the terms “solid support” and “solid surface” refers to discrete solid or semi-solid surface. A solid support may encompass any type of solid, porous, or hollow sphere, ball, cylinder, or other similar configuration composed of plastic, ceramic, metal, or polymeric material (e.g., hydrogel) onto which a nucleic acid may be immobilized (e.g., covalently or non-covalently). A nonporous substrate generally provides a seal against bulk flow of liquids or gases. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located within a flow cell. Solid surfaces can also be varied in their shape depending on the application in a method described herein. For example, a solid surface useful herein can be planar, or contain regions which are concave or convex. In embodiments, the geometry of the concave or convex regions (e.g., wells) of the solid surface conform to the size and shape of the particle to maximize the contact between as substantially circular particle. In embodiments, the wells of an array are randomly located such that nearest neighbor features have random spacing between each other. Alternatively, in embodiments the spacing between the wells can be ordered, for example, forming a regular pattern. The term solid substrate is encompassing of a substrate (e.g., a flow cell) having a surface including a polymer coating covalently attached thereto. In embodiments, the solid substrate is a flow cell. The term “flow cell” as used herein refers to a chamber including a solid surface across which one or more fluid reagents can be flowed. Examples of flow cells and related fluidic systems and detection platforms that can be readily used in the methods of the present disclosure are described, for example, in Bentley et al., Nature 456:53-59 (2008). In certain embodiments a substrate includes a surface (e.g., a surface of a flow cell, a surface of a tube, a surface of a chip), for example a metal surface (e.g., steel, gold, silver, aluminum, silicon and copper). In embodiments a substrate (e.g., a substrate surface) is coated and/or includes functional groups and/or inert materials. In certain embodiments a substrate includes a bead, a chip, a capillary, a plate, a membrane, a wafer (e.g., silicon wafers), a comb, or a pin for example. In some embodiments a substrate includes a bead and/or a nanoparticle. A substrate can be made of a suitable material, non-limiting examples of which include a plastic or a suitable polymer (e.g., polycarbonate, poly (vinyl alcohol), poly (divinylbenzene), polystyrene, polyamide, polyester, polyvinylidene difluoride (PVDF), polyethylene, polyurethane, polypropylene, and the like), borosilicate, glass, nylon, Wang resin, Merrifield resin, metal (e.g., iron, a metal alloy, sepharose, agarose, polyacrylamide, dextran, cellulose and the like or combinations thereof. In embodiments a substrate includes a magnetic material (e.g., iron, nickel, cobalt, platinum, aluminum, and the like). In embodiments a substrate includes a magnetic bead (e.g., DYNABEADS®, hematite, AMPure XP). Magnets can be used to purify and/or capture nucleic acids bound to certain substrates (e.g., substrates including a metal or magnetic material). The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. For example, materials that are transparent to a desired wavelength of radiation are useful for analytical techniques that will utilize radiation of the desired wavelength. Conversely, it may be desirable to select a material that does not pass radiation of a certain wavelength (e.g., being opaque, absorptive, or reflective). In embodiments, the material of the flow cell is selected due to the ability to conduct thermal energy. In embodiments, a flow cell includes inlet and outlet ports and a flow channel extending there between.

The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

The term “microplate”, or “multiwell container” as used herein, refers to a substrate including a surface, the surface including a plurality of reaction chambers separated from each other by interstitial regions on the surface. In embodiments, the microplate has dimensions as provided and described by American National Standards Institute (ANSI) and Society for Laboratory Automation And Screening (SLAS); for example the tolerances and dimensions set forth in ANSI SLAS 1-2004 (R2012); ANSI SLAS 2-2004 (R2012); ANSI SLAS 3-2004 (R2012); ANSI SLAS 4-2004 (R2012); and ANSI SLAS 6-2012, which are incorporated herein by reference. The dimensions of the microplate as described herein and the arrangement of the reaction chambers may be compatible with an established format for automated laboratory equipment. In embodiments, the device described herein provides methods for high-throughput screening. High-throughput screening (HTS) refers to a process that uses a combination of modern robotics, data processing and control software, liquid handling devices, and/or sensitive detectors, to efficiently process a large amount of (e.g., thousands, hundreds of thousands, or millions) samples in biochemical, genetic, or pharmacological experiments, either in parallel or in sequence, within a reasonably short period of time (e.g., days). Preferably, the process is amenable to automation, such as robotic simultaneous handling of 96 samples, 384 samples, 1536 samples or more. A typical HTS robot tests up to 100,000 to a few hundred thousand compounds per day. The samples are often in small volumes, such as no more than 1 mL, 500 μl, 200 μl, 100 μl, 50 μl or less. Through this process, one can rapidly identify active compounds, small molecules, antibodies, proteins or polynucleotides in a cell.

The reaction chambers may be provided as wells of a multiwell container (alternatively referred to as reaction chambers), for example a microplate may contain 2, 4, 6, 12, 24, 48, 96, 384, or 1536 sample wells. In embodiments, the 96 and 384 wells are arranged in a 2:3 rectangular matrix. In embodiments, the 24 wells are arranged in a 3:8 rectangular matrix. In embodiments, the 48 wells are arranged in a 3:4 rectangular matrix. In embodiments, the reaction chamber is a microscope slide (e.g., a glass slide about 75 mm by about 25 mm). In embodiments the slide is a concavity slide (e.g., the slide includes a depression). In embodiments, the slide includes a coating for enhanced cell adhesion (e.g., poly-L-lysine, silanes, carbon nanotubes, polymers, epoxy resins, or gold). In embodiments, the microplate is about 5 inches by about 3.33 inches, and includes a plurality of 5 mm diameter wells. In embodiments, the microplate is about 5 inches by about 3.33 inches, and includes a plurality of 6 mm diameter wells. In embodiments, the microplate is about 5 inches by about 3.33 inches, and includes a plurality of 7 mm diameter wells. In embodiments, the microplate is about 5 inches by about 3.33 inches, and includes a plurality of 7.5 mm diameter wells. In embodiments, the microplate is 5 inches by 3.33 inches, and includes a plurality of 7.5 mm diameter wells. In embodiments, the microplate is about 5 inches by about 3.33 inches, and includes a plurality of 8 mm diameter wells. In embodiments, the microplate is a flat glass or plastic tray in which an array of wells are formed, wherein each well can hold between from a few microliters to hundreds of microliters of fluid reagents and samples. In embodiments, the microplate has a rectangular shape that measures 127.7 mm±0.5 mm in length by 85.4 mm±0.5 mm in width, and includes 6, 12, 24, 48, or 96 wells, wherein each well has an average diameter of about 5-7 mm. In embodiments, the microplate has a rectangular shape that measures 127.7 mm±0.5 mm in length by 85.4 mm±0.5 mm in width, and includes 6, 12, 24, 48, or 96 wells, wherein each well has an average diameter of about 6 mm.

The term “well” refers to a discrete concave feature in a substrate having a surface opening that is completely surrounded by interstitial region(s) of the surface. Wells can have any of a variety of shapes at their opening in a surface including but not limited to round, elliptical, square, polygonal, or star shaped (i.e., star shaped with any number of vertices). The cross section of a well taken orthogonally with the surface may be curved, square, polygonal, hyperbolic, conical, or angular. The wells of a microplate are available in different shapes, for example F-Bottom: flat bottom; C-Bottom: bottom with minimal rounded edges; V-Bottom: V-shaped bottom; or U-Bottom: U-shaped bottom. In embodiments, the well is substantially square. In embodiments, the well is square. In embodiments, the well is F-bottom. In embodiments, the microplate includes 24 substantially round flat bottom wells. In embodiments, the microplate includes 48 substantially round flat bottom wells. In embodiments, the microplate includes 96 substantially round flat bottom wells. In embodiments, the microplate includes 384 substantially square flat bottom wells.

The discrete regions (i.e., features, wells) of the microplate may have defined locations in a regular array, which may correspond to a rectilinear pattern, circular pattern, hexagonal pattern, or the like. In embodiments, the pattern of wells includes concentric circles of regions, spiral patterns, rectilinear patterns, hexagonal patterns, and the like. In embodiments, the pattern of wells is arranged in a rectilinear or hexagonal pattern A regular array of such regions is advantageous for detection and data analysis of signals collected from the arrays during an analysis. These discrete regions are separated by interstitial regions. As used herein, the term “interstitial region” refers to an area in a substrate or on a surface that separates other areas of the substrate or surface. For example, an interstitial region can separate one concave feature of an array from another concave feature of the array. The two regions that are separated from each other can be discrete, lacking contact with each other. In another example, an interstitial region can separate a first portion of a feature from a second portion of a feature. In embodiments the interstitial region is continuous whereas the features are discrete, for example, as is the case for an array of wells in an otherwise continuous surface. The separation provided by an interstitial region can be partial or full separation. In embodiments, interstitial regions have a surface material that differs from the surface material of the wells (e.g., the interstitial region contains a photoresist and the surface of the well is glass). In embodiments, interstitial regions have a surface material that is the same as the surface material of the wells (e.g., both the surface of the interstitial region and the surface of well contain a polymer or copolymer).

As used herein, the terms “biomolecule” or “analyte” refer to an agent (e.g., a compound, macromolecule, or small molecule), and the like derived from a biological system (e.g., an organism, a cell, or a tissue). The biomolecule may contain multiple individual components that collectively construct the biomolecule, for example, in embodiments, the biomolecule is a polynucleotide wherein the polynucleotide is composed of nucleotide monomers. The biomolecule may be or may include DNA, RNA, organelles, carbohydrates, lipids, proteins, or any combination thereof. These components may be extracellular. In some examples, the biomolecule may be referred to as a clump or aggregate of combinations of components. In some instances, the biomolecule may include one or more constituents of a cell but may not include other constituents of the cell. In embodiments, a biomolecule is a molecule produced by a biological system (e.g., an organism). The biomolecule may be any substance (e.g. molecule) or entity that is desired to be detected by the method of the invention. In embodiments, the biomolecule is the “target” of the assay methods described herein. The biomolecule may accordingly be any compound that may be desired to be detected, for example a peptide or protein, or nucleic acid molecule or a small molecule, including organic and inorganic molecules. The biomolecule may be a cell or a microorganism, including a virus, or a fragment or product thereof. Biomolecules of particular interest may thus include proteinaceous molecules such as peptides, polypeptides, proteins or prions or any molecule which includes a protein or polypeptide component, etc., or fragments thereof. The biomolecule may be a single molecule or a complex that contains two or more molecular subunits, which may or may not be covalently bound to one another, and which may be the same or different. Thus, in addition to cells or microorganisms, such a complex biomolecule may also be a protein complex. Such a complex may thus be a homo- or hetero-multimer. Aggregates of molecules e.g., proteins may also be target analytes, for example aggregates of the same protein or different proteins. The biomolecule may also be a complex between proteins or peptides and nucleic acid molecules such as DNA or RNA. Of particular interest may be the interactions between proteins and nucleic acids, e.g., regulatory factors, such as transcription factors, and interactions between DNA or RNA molecules.

As used herein, “biomaterial” refers to any biological material produced by an organism. In some embodiments, biomaterial includes secretions, extracellular matrix, proteins, lipids, organelles, membranes, cells, portions thereof, and combinations thereof. In some embodiments, cellular material includes secretions, extracellular matrix, proteins, lipids, organelles, membranes, cells, portions thereof, and combinations thereof. In some embodiments, biomaterial includes viruses. In some embodiments, the biomaterial is a replicating virus and thus includes virus infected cells. In embodiments, a biological sample includes biomaterials.

The term “cellular component” is used in accordance with its ordinary meaning in the art and refers to any organelle, nucleic acid, protein, or analyte that is found in a prokaryotic, eukaryotic, archaeal, or other organismic cell type. Examples of cellular components (e.g., a component of a cell) include RNA transcripts, proteins, membranes, lipids, and other analytes.

In some embodiments, a sample includes one or more nucleic acids, or fragments thereof. A sample can include nucleic acids obtained from one or more subjects. In some embodiments a sample includes nucleic acid obtained from a single subject. In some embodiments, a sample includes a mixture of nucleic acids. A mixture of nucleic acids can include two or more nucleic acid species having different nucleotide sequences, different fragment lengths, different origins (e.g., genomic origins, cell or tissue origins, subject origins, the like or combinations thereof), or combinations thereof. A sample may include synthetic nucleic acid.

A subject can be any living or non-living organism, including but not limited to a human, non-human animal, plant, bacterium, fungus, virus or protist. A subject may be any age (e.g., an embryo, a fetus, infant, child, adult). A subject can be of any sex (e.g., male, female, or combination thereof). A subject may be pregnant. In some embodiments, a subject is a mammal. In some embodiments, a subject is a human subject. A subject can be a patient (e.g., a human patient). In some embodiments a subject is suspected of having a genetic variation or a disease or condition associated with a genetic variation

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Methods

In an aspect is provided a method of imaging a solid support including a plurality of features. In embodiments, the method includes obtaining an image of the solid support using a detection apparatus, wherein the solid support includes a plurality of features, wherein one or more features include a fluorescent emission. For example, the plurality may includes a first feature including a fluorescent emission and a second feature including a second fluorescent emission. In embodiments, the method includes providing the image or image-related data to a computer, wherein the computer includes parameter data of the solid support; executing the following on the computer: applying an intensity threshold function to the image or image-related data to provide a masked image; fitting the masked image to a corrugation function; detecting features from the image.

In embodiments, the method includes analyzing sequential images of a solid support including a plurality of features, the method comprising obtaining a first image and a second image of the solid support using a detection apparatus, wherein the solid support includes a first feature comprising a fluorescent emission and a second feature comprising a second fluorescent emission; providing the first image and the second image or image-related data to a computer, wherein the computer comprises parameter data of the solid support; executing the following on the computer for each image: applying an intensity threshold function to the image or image-related data to provide a masked image; fitting the masked image to a corrugation function; detecting features from the image; and aligning features detected in the first image with features detected in the second image based on the parameter data of the solid support.

In embodiments, the solid support may include substrates such as patterned flow cells used in next-generation sequencing, microarrays for biomolecular analysis, or lithographic wafers for semiconductor fabrication, each comprising a plurality of features. The features may include amplification clusters of nucleic acids labeled with fluorescent tags in sequencing applications, fluorescently labeled spots representing oligonucleotide probes in microarrays, or etched pits or pillars in lithographic processes. The features are typically arranged in a regular grid pattern, such as hexagonal or rectangular arrays, with a center-to-center spacing of approximately 200-600 nanometers, resulting in feature densities of up to millions per square millimeter, depending on the application. In embodiments, the solid support includes a plurality of features.

The methods described herein can be used in conjunction with a variety of nucleic acid sequencing techniques. Particularly applicable techniques are those wherein nucleic acids are attached at fixed locations in an array such that their relative positions do not change and wherein the array is repeatedly imaged. Embodiments in which images are obtained in different color channels, for example, coinciding with different labels used to distinguish one nucleotide base type from another are particularly applicable. In some embodiments, the process to determine the nucleotide sequence of a target nucleic acid can be an automated process. Preferred embodiments include sequencing-by-synthesis (“SBS”) techniques. SBS techniques generally involve the enzymatic extension of a nascent nucleic acid strand through the iterative addition of nucleotides against a template strand. SBS techniques can utilize nucleotides that have a label moiety or those that lack a label moiety. Accordingly, incorporation events can be detected based on a characteristic of the label, such as fluorescence of the label. In embodiments, where two or more different nucleotides are present in a sequencing reagent, the different nucleotides can be distinguishable from each other, or alternatively, the two or more different labels can be the indistinguishable under the detection techniques being used.

In embodiments, the method includes providing the image or image-related data to a computer, wherein the computer includes parameter data of the solid support, such as the expected grid geometry (e.g., hexagonal, rectangular), the feature dimensions (e.g., diameter or area of fluorescent spots or physical pits), the center-to-center spacing of the features, and other calibration data specific to the imaging system or solid support.

In embodiments, the method includes executing the following on the computer. 1. Applying an Intensity Threshold Function: analyzing the image or image-related data to differentiate high-intensity regions representing features from the background. The intensity threshold function may use a global threshold, an adaptive threshold based on local brightness variations, or a statistical threshold derived from pixel intensity distributions. For example, in a noisy image with Poissonian noise, an intensity threshold of twice the median pixel intensity may be applied to mask out non-feature regions, resulting in a binary or semi-binary masked image. Several techniques can be employed, such as: global thresholding (a single intensity value is chosen based on the overall pixel brightness distribution); adaptive thresholding (the threshold adapts dynamically based on local brightness variations, ensuring consistent feature extraction across regions with uneven illumination); and/or statistical thresholding (derived from the pixel intensity distribution, such as using twice the median intensity as the threshold, which can reduce sensitivity to extreme outliers). These thresholds create a binary or semi-binary masked image, where regions below the threshold are suppressed. For example, in a noisy fluorescence image with features having peak intensities of 300 counts, applying an adaptive threshold around 100 counts ensures that only the brightest regions corresponding to features are retained. 2. Fitting the Masked Image to a Corrugation Function: The masked image is then analyzed to align it with a corrugation function, which mathematically represents the periodic structure of the features on the solid support. For instance, in the case of a hexagonal grid, the corrugation function may include sinusoidal components that model the spatial arrangement of the features. The fitting process may involve optimizing parameters such as grid pitch, rotation angle, skew, and phase offsets to best match the observed pattern, which can account for global distortions or alignments and refine the understanding of the feature layout. 33 Detecting Features from the Image: Based on the fitted corrugation function, the locations of individual features are identified. This may involve calculating the vertex positions where the corrugation function predicts feature presence and cross-referencing these predictions with the high-intensity regions in the original or masked image. For example, detected features may be output as a set of coordinates corresponding to the positions of amplification clusters, fluorescent spots, or etched patterns, enabling further analysis such as quality control, positional accuracy, or downstream sequencing data processing.

The method includes providing the image or image-related data to a computer, wherein the computer contains parameter data of the solid support, such as grid geometry, feature dimensions, center-to-center spacing, and calibration data. The first computational step involves applying an intensity threshold function to the image. This step differentiates high-intensity regions representing features from the background, enhancing contrast and suppressing noise. Various thresholding techniques may be employed, including global thresholds, where a single intensity value is chosen based on the overall brightness distribution, or adaptive thresholds, where the threshold varies dynamically according to local brightness variations. Another approach utilizes statistical thresholds derived from pixel intensity distributions, such as setting the threshold at twice the median intensity to mitigate the impact of noise outliers. Applying these thresholds results in a binary or semi-binary masked image, where regions below the threshold are suppressed, retaining only the most relevant portions of the image for further processing. Following thresholding, the masked image is fitted to a corrugation function that represents the periodic structure of the features on the solid support. For a hexagonal grid, the corrugation function may include sinusoidal components that model the spatial arrangement of features, with parameters such as amplitude, wave vectors, and phase offsets adjusted to align with the observed grid. For rectangular grids, the corrugation function incorporates independent periodicities along orthogonal axes to account for differing spacings in the x and y directions. During the fitting process, the algorithm optimizes parameters such as grid pitch, rotation angle, skew, and phase offsets to achieve the best alignment. Optimization may be performed using iterative techniques such as least squares fitting, which minimizes the difference between the observed and modeled data. This step also addresses potential distortions, including those caused by manufacturing defects or motion artifacts, ensuring precise grid alignment even under challenging imaging conditions. The final computational step involves detecting individual features within the image based on the fitted corrugation function. The algorithm identifies the precise positions of grid vertices where features are expected, as predicted by the corrugation model. These predicted locations are cross-referenced with the high-intensity regions in the original or masked image to confirm the presence of features. For example, a feature may be confirmed if its predicted vertex aligns with a region exceeding a specified intensity threshold. The detected features are then output as a coordinate list, along with additional attributes such as intensity, shape, or area, enabling further analysis. This detection process ensures that features such as amplification clusters, fluorescent spots, or etched patterns are accurately localized, supporting downstream applications such as quality control, positional accuracy assessment, and sequencing alignment.

In embodiments, the intensity threshold function includes an adaptive threshold. The adaptive threshold dynamically adjusts to variations in local brightness within the image, improving feature detection accuracy in regions with uneven illumination or variable background noise. For example, in a fluorescence image where certain regions are brighter due to local variations in excitation intensity, the adaptive threshold calculates a threshold value for each pixel based on the brightness statistics of its surrounding neighborhood. This ensures that features in both bright and dim regions are effectively detected, reducing the likelihood of false negatives or missed features caused by a global threshold being either too high or too low.

In embodiments, fitting the masked image to a corrugation function includes optimizing parameters of the corrugation function. The optimization process involves iteratively adjusting parameters of the corrugation function to achieve the closest match to the observed pattern of features in the masked image. Parameters subject to optimization may include the grid pitch, which defines the center-to-center spacing between adjacent features; the orientation angle, which specifies the rotational alignment of the grid relative to a reference axis; and the skew, which accounts for distortions where grid lines deviate from their ideal parallel or perpendicular arrangement. Phase offsets are also refined to align the grid vertices precisely with the detected feature locations. The optimization process typically employs mathematical techniques such as gradient descent, nonlinear least-squares fitting, or stochastic methods like Monte Carlo simulations to minimize the error between the corrugation function and the observed feature layout. For instance, the algorithm may initialize parameters based on an approximate grid geometry and iteratively adjust them until the residual error (i.e., the difference between predicted and observed feature intensities or positions) is below a predefined threshold.

In embodiments, the method includes computationally applying corrections to the parameter data of the solid support to account for local distortions, wherein the corrections include adjusting the grid pitch and rotation angle of the corrugation function. The computational corrections involve analyzing deviations between the observed feature positions and the expected grid pattern defined by the parameter data of the solid support. Local distortions may arise due to manufacturing imperfections in the solid support, such as slight variations in feature spacing, or due to imaging artifacts, such as motion-induced blurring or lens-induced skew. To account for these distortions, the grid pitch can be adjusted to reflect variations in the apparent spacing of features, ensuring the corrugation function accurately represents the observed grid geometry. For instance, if localized compression or stretching of the grid is detected, the pitch in specific regions may be modified to match the actual inter-feature distances. Similarly, the rotation angle of the corrugation function can be refined to compensate for any misalignment of the grid relative to the imaging plane, such as tilt or rotational shifts introduced during sample preparation or imaging. The corrections may be applied iteratively, leveraging techniques like localized least-squares fitting or adaptive optimization, to ensure the corrected grid aligns closely with the feature layout across the entire image.

In embodiments, fitting the masked image to a corrugation function includes fitting the masked image to a corrugation function configured to model a non-hexagonal grid geometry, including rectangular, triangular, or irregular grid. The corrugation function can be tailored to represent various grid geometries beyond a hexagonal pattern, enabling flexibility in analyzing feature arrangements on the solid support. For a rectangular grid, the corrugation function may incorporate independent periodicities along the x- and y-axes. For a triangular grid, the function can be adapted to account for the unique arrangement of features, such as periodicities with angular offsets. Irregular grids may involve customized corrugation functions incorporating non-uniform periodicities or localized distortions to approximate irregular feature arrangements. For an irregular grid, the corrugation function is adapted to account for non-uniform spacing or distortions in the feature arrangement. Unlike periodic grids, where feature positions follow predictable patterns, irregular grids may exhibit variable inter-feature distances or lack consistent alignment. The corrugation function for an irregular grid may incorporate localized adjustments to grid parameters, such as varying the pitch and phase offsets on a region-by-region basis. For example, an irregular grid might be represented by a piecewise-defined corrugation function, where each subregion of the image has its own set of optimized parameters, or by a higher-order polynomial function that captures the gradual variations in grid geometry. Computational techniques such as spline fitting or weighted least squares may be employed to iteratively refine the model to best match the observed feature layout.

Image analysis algorithms or processes useful for extracting signals from randomly located points, such as fluorescent beads, generally include two steps: i) detecting the point locations, and ii) extracting the fluorescent intensities from those point locations. For example, a first feature may be detected at (x₁, y₁, z₁) with a fluorescent intensity at that position, I₁(x₁, y₁, z₁), while a second feature is detected at (x₂, y₂, z₂) having fluorescent intensity, I₂(x₂, y₂, z₂). This feature extraction typically works well under low density conditions, i.e., when there is significant distance between neighboring points. However, neither of the two steps account for the proximity of neighboring features. As the density of points of the image increases, the accuracy of such algorithms can degrade due to the spatial overlap of images. Such degradation tends to cause errors in both steps of the aforementioned algorithm.

Approaches to account for and potentially correct errors caused by overlapping images include introducing a point spread function (PSF), which serves to deconvolute the feature before the detection of the feature. The overlapping images and subsequent overlapping PSFs, can act to couple the location and intensities of the feature allowing for a joint solution for these quantities in each local neighborhood of the image. This can be done by, for example, minimizing the squared error between the image patch and its model over the space of candidate locations and intensities, where the model is constructed using an exemplar feature shape (e.g., a circle) and the PSF. However, this can significantly increase the computational load and may be more prone to introducing aberrations due to the technical complexity of implementing a PSF-corrected image.

A significant improvement may be achieved by arranging otherwise random distribution of features onto an ordered array (i.e., a pattern). For example, with the features arranged on a regular grid, there is no need to detect individual feature locations since the locations (x, y, z) are fixed and known. Note, the ordered pattern or ordered array does not necessarily need to be rectilinear (e.g., an x-y format of features that are in rows and columns), so long as the feature pattern and corresponding interstitial regions is known. The feature pattern is then registered with respect to a pixel grid. The pattern registration is described by a small number of parameters or parameter data, such as the grid orientation angle, the apparent pitch in pixel units, and the phase of the feature grid at some fixed pixel location. These parameters are determined from an average over features, so that even if the signal-to-noise ratio of an individual feature is low, accurate sub-pixel registration is possible. By knowing the pattern registration, it is then a matter to calculate the locations of all features, such that the only the intensities need to be determined, thereby reducing the number of variables threefold.

As a sequencing run progresses, multiple images of the pattern with the same parameters (e.g., pitch, orientation angle, etc.) are taken over and over. The feature intensities and pixel intensities vary cycle-to-cycle (i.e., the feature and pixel intensities vary each sequencing cycle), but the underlying pattern is immutable.

The pattern may be a regular hexagonal grid with known nominal pitch and orientation angle. The pattern pitch and angle may have deviations from the nominal; e.g., <2% deviation is expected for the pitch to account for the variability in the imaging optics magnification. The pattern pitch and angle may also vary across the image due to the distortion of the optics. For example, less than about 1% distortion is expected. In embodiments, the pattern is ordered in a lattice, e.g., a hexagonal lattice or Bravais lattice. In embodiments, the pattern is ordered in a cubic, hexagonal, rhombohedral, tetragonal, orthorhombic, monoclinic, or a triclinic lattice. Alternatively, in embodiments, the pattern may be a random pattern (i.e., a non-hexagonal grid). Note, the ordered pattern or ordered array (e.g., an ordered lattice) does not necessarily need to be rectilinear (e.g., an x-y format of features that are in rows and columns), so long as the feature pattern and corresponding interstitial regions is known.

In embodiments, the method includes assigning an index address for each feature; and quantifying a signal level of each feature. The index address may correspond to the spatial coordinates of each feature on the solid support, such as a unique integer vector representing its location within a predefined grid. For example, in a hexagonal grid, the index address may be represented as (m,n), where m and n are integers corresponding to the row and column positions of the feature. Quantifying the signal level may involve measuring the fluorescence intensity emitted by each feature, normalized against a background intensity level, to provide accurate metrics for subsequent analysis such as quality control or sequencing alignment.

In embodiments, the method includes building a model of each image incorporating known feature locations the index address for each feature. The model may represent the spatial arrangement of features on the solid support as a matrix, where each entry corresponds to an index address and is associated with specific attributes of the feature, such as its intensity or location relative to the grid. For example, a hexagonal grid model may use a two-dimensional array indexed by row and column values (m, n), with each entry storing the detected signal level and alignment parameters for the corresponding feature. The model can facilitate subsequent analyses, such as comparing observed feature locations to expected grid positions or aligning data across multiple images in a series.

In embodiments, the model includes a matrix and is stored in computer memory or a computer-readable medium. The matrix may represent the spatial arrangement of features on the solid support, with each element of the matrix corresponding to a feature's index address and associated attributes, such as signal intensity or positional offsets from a grid. For instance, in a 200×200 grid, the matrix may store fluorescence intensity values at each feature location. The matrix can be stored in computer memory for real-time processing or saved on a computer-readable medium, such as a hard drive or cloud-based storage, for subsequent analysis or reuse in other imaging workflows.

In embodiments, the matrix is reused for a different image. The matrix, representing the spatial arrangement of features and their index addresses, can be applied to a new image of the same solid support to streamline feature detection and analysis. For example, in a sequencing process, the matrix generated from an initial cycle may be reused for subsequent cycles, aligning the detected features across the series of images without needing to reinitialize the grid-fitting process. The reuse improves computational efficiency and ensures consistency in feature tracking across multiple images.

In embodiments, each index address is a unique address. The unique index address may uniquely identify a feature within the grid based on its spatial coordinates or position relative to the grid origin. For example, in a hexagonal grid, the index address may be represented as a pair of integers (m, n) corresponding to the row and column of the feature. Each address ensures that no two features share the same identifier, enabling feature-specific data retrieval and tracking, particularly in high-density grids where millions of features are present. In embodiments, each unique address is an integer vector of length 2. The integer vector may represent the grid coordinates of a feature in a two-dimensional array, where the first integer corresponds to the row number (m) and the second integer corresponds to the column number (n). For example, a feature located at the third row and fifth column of a hexagonal grid may have an index address represented as (3,5). Vector length is a compact representation and facilitates efficient storage and rapid retrieval of feature-specific data during image processing and analysis.

In embodiments, the method further includes obtaining a plurality of images of the solid support. The plurality of images may be captured under varying conditions, such as different fluorescent excitation wavelengths, to distinguish features emitting at distinct spectral ranges. For example, one image may capture emissions corresponding to a first fluorescent tag, while another image captures emissions from a second tag, enabling the differentiation of multiple feature types on the same solid support. Alternatively, the images may be taken at successive time points to monitor changes in the features, such as signal intensity fluctuations during a sequencing reaction.

In embodiments, the method includes obtaining a series of images of the solid support. The series of images may be captured during successive cycles of a process, such as sequencing-by-synthesis, where each image corresponds to the incorporation of a nucleotide labeled with a distinct fluorescent tag. For example, the first image in the series may capture signals from a base incorporation event, while subsequent images monitor additional incorporation events at the same feature locations. The series of images enables temporal tracking of feature activity and supports the reconstruction of sequences or dynamic processes occurring on the solid support.

In embodiments, the first feature and/or the second corresponds to a discrete plurality of nucleic acid molecules. The discrete plurality of nucleic acid molecules may include amplification clusters or individual strands immobilized on the solid support during a sequencing process. For example, the first feature may correspond to a cluster of DNA molecules labeled with a fluorescent tag specific to adenine, while the second feature corresponds to a cluster labeled for thymine. These features are spatially distinct and emit characteristic fluorescent signals upon excitation, enabling their detection and differentiation in the image.

In embodiments, fluorescent features are assumed to be located on the hexagonal grid and are assumed to be similar in size and shape. Alternative grid orientations are contemplated. The commonly known hexagonal grid, renowned for its efficient packing and surface coverage, is just one among several strategic designs. Square grids, characterized by their perpendicular lines forming squares, offer uniformity and simplicity, making them ideal for applications where consistent design and straightforward properties are essential. The rectangular grids, a variation of the square pattern, provide added flexibility in terms of aspect ratios, thereby influencing different properties along the two principal axes. Equally significant are triangular grids, composed of equilateral triangles, which stand out for their high packing density and are especially beneficial in optical applications due to their unique diffraction properties. The honeycomb grid, while similar to the hexagonal grid in using hexagons, offers a distinct arrangement and is adept at optimizing strength-to-weight ratios. Quasicrystalline patterns, with their non-repeating yet orderly formations, are critical in applications requiring unique diffraction or scattering properties. Random or stochastic grids, which depart from regular grid structures, are crucial in scenarios where isotropy or controlled non-uniformity is required. Collectively, these grid orientations (i.e., hexagonal, square, rectangular, triangular, honeycomb, quasicrystalline, and random) highlight the versatility grid orientations.

In embodiments, the image is of a biological sample (e.g., a tissue). In embodiments, the image is of a solid support including a plurality of discrete features (e.g., amplification products attached to the solid support).

In embodiments, the image does not contain a focusing bead. In embodiments, the image includes a focusing bead. Focusing beads are high brightness features that are similar in size to the sequencing features. Focusing beads may adhere to the same grid pattern as the sequencing features. Alternatively, the focusing beads may be randomly placed.

In embodiments, each image contains one or more fiducials that serve as the origin for indexing of the features and tracking them cycle-to-cycle (i.e., tracking them every sequencing cycle). The term “fiducial” is intended to mean a distinguishable point of reference in or on an object. The point of reference can be, for example, a mark, second object, shape, edge, area, irregularity, channel, pit, post or the like. The point of reference can be present in an image of the object or in another data set derived from detecting the object. The point of reference can be specified by an x and/or y coordinate in a plane of the object. Alternatively, the point of reference can be specified by a z coordinate that is orthogonal to the xy plane, for example, being defined by the relative locations of the object and a detector.

The image analysis may use the following inputs, which are non-limiting examples: a set of four-channel (i.e., four-color) images corresponding to sequencing cycles of one tile; a four-channel image of focusing beads (if present); a configuration file describing the pattern parameters (e.g., nominal pitch and orientation of the pattern, the pixel pitch, etc.); and optionally, a file of pre-computed extraction matrices. In embodiments, the image analysis includes a set of four-channel (i.e., four-color) images corresponding to sequencing cycles of one tile as an input. In embodiments, the image analysis includes a four-channel image of focusing beads (if present) as an input. In embodiments, the image analysis includes a configuration file describing the pattern parameters (e.g., nominal pitch and orientation of the pattern, the pixel pitch, etc.) as an input. In embodiments, the image analysis includes a file of pre-computed extraction matrices as an input. The image analysis process can output, for example, a single file (e.g., an HDF5 file) per cycle listing for every feature detected, including feature center coordinates in image pixels; a feature index; extracted signal levels (i.e., intensity values); and a single file per cycle with extracted intensities. The image analysis process can output, for example, a one or more files in a suitable format that includes information for every feature detected, including feature center coordinates in image pixels; a feature index; extracted signal levels (i.e., intensity values). In embodiments, the image analysis process provides a single electronic computer-readable data file per cycle with extracted intensities.

In embodiments, the parameter data relates to a grid orientation angle. The grid orientation angle may define the rotational alignment of the feature grid relative to a reference axis, such as the horizontal axis of the image. For example, a hexagonal grid may be oriented at an angle of 30 degrees from the horizontal, as determined during the fitting of the masked image to the corrugation function. This parameter allows accurate alignment of the detected features with the expected grid geometry, compensating for potential misalignment caused by imaging or sample placement variations.

In embodiments, the parameter data relates to an apparent pitch in pixel units. The apparent pitch in pixel units may represent the distance between adjacent features on the grid as observed in the image. For instance, in a hexagonal grid, the pitch may correspond to the center-to-center distance between neighboring features, such as 300 pixels for a grid with high feature density. This parameter is critical for accurately fitting the corrugation function to the masked image, ensuring that the detected grid matches the physical layout of the features on the solid support. Adjustments to the apparent pitch can also account for magnification or scaling differences introduced during imaging. In embodiments, a pixel corresponds to about 200-400 nm. In embodiments, a pixel corresponds to 200 nm. In embodiments, a pixel corresponds to 250 nm. In embodiments, a pixel corresponds to 300 nm. In embodiments, a pixel corresponds to 350 nm. In embodiments, a pixel corresponds to 400 nm.

In embodiments, the parameter data relates to a phase of a feature grid at a fixed pixel location of the image. The phase of the feature grid at a fixed pixel location may define the offset of the grid pattern relative to a reference point in the image, such as the pixel at the center or corner of the field of view. For example, a phase value of ϕₓ=0.5 and ϕ_{y}=0.2 might indicate that the grid vertices are shifted by half a grid pitch in the x-direction and by 20% of a grid pitch in the y-direction at the reference pixel. The phase parameter is helpful for aligning the corrugation function with the observed feature pattern, particularly when dealing with localized distortions or initial alignment errors in the image.

In another aspect is provided a computer-implemented method for analyzing electronic images of a biological sample (e.g., cells or tissues or biomolecules). In embodiments, the method includes obtaining an image of the solid support using a detection apparatus, wherein the solid support comprises a first feature comprising a fluorescent emission and a second feature comprising a second fluorescent emission; providing an image or image-related data to a computer, wherein the image comprises a plurality of fluorescent features associated with the biological sample on a solid support, and wherein the computer comprises parameter data of the solid support; executing the following on the computer: applying an intensity threshold function to the image or image-related data to provide a masked image; fitting the masked image to a corrugation function; and detecting features from the image. In embodiments, the method generates one or more data set(s). For example, the signal signatures may be stored as a data set.

In embodiments, a signal signature is a fluorescent emission. For example, a signal signature may be generated by detecting an excited fluorophore associated with the target. In embodiments, generating a signal signature includes detecting a series of fluorescent emissions associated with the target sequence (e.g., a barcode sequence, or a sequence useful for identifying the target). In embodiments, detecting includes fluorescent microscopy. In fluorescence microscopy, a sample is illuminated with light of a wavelength which excites fluorescence in the sample. The fluoresced light, which is usually at a longer wavelength than the illumination, is then imaged through a microscope objective. Two filters may be used in this technique; an illumination (or excitation) filter which ensures the illumination is near monochromatic and at the correct wavelength, and a second emission (or barrier) filter which ensures none of the excitation light source reaches the detector. Alternatively, these functions may both be accomplished by a single dichroic filter.

In embodiments, generating a signal signature includes sequencing. In embodiments, sequencing includes sequencing by synthesis, sequencing by binding, sequencing by ligation, or pyrosequencing. In embodiments, sequencing includes extending a sequencing primer by incorporating a labeled nucleotide or labeled nucleotide analogue, and detecting the label to generate a signal for each incorporated nucleotide or nucleotide analogue, wherein the sequencing primer is hybridized to the extension product. In embodiments, the sequencing primer includes a sequence of the subject sequence.

In embodiments, the method includes sequencing the oligonucleotide and/or the amplification products. A variety of sequencing methodologies can be used such as sequencing-by synthesis (SBS), pyrosequencing, sequencing by ligation (SBL), or sequencing by hybridization (SBH). Pyrosequencing detects the release of inorganic pyrophosphate (PPi) as particular nucleotides are incorporated into a nascent nucleic acid strand (Ronaghi, et al., Analytical Biochemistry 242(1), 84-9 (1996); Ronaghi, Genome Res. 11(1), 3-11 (2001); Ronaghi et al. Science 281 (5375), 363 (1998); U.S. Pat. Nos. 6,210,891; 6,258,568; and. 6,274,320, each of which is incorporated herein by reference in its entirety). In pyrosequencing, released PPi can be detected by being converted to adenosine triphosphate (ATP) by ATP sulfurylase, and the level of ATP generated can be detected via light produced by luciferase. In this manner, the sequencing reaction can be monitored via a luminescence detection system. In both SBL and SBH methods, target nucleic acids, and amplicons thereof, are subjected to repeated cycles of oligonucleotide delivery and detection. SBL methods, include those described in Shendure et al. Science 309:1728-1732 (2005); U.S. Pat. Nos. 5,599,675; and 5,750,341, each of which is incorporated herein by reference in its entirety; and the SBH methodologies are as described in Bains et al., Journal of Theoretical Biology 135(3), 303-7 (1988); Drmanac et al., Nature Biotechnology 16, 54-58 (1998); Fodor et al., Science 251 (4995), 767-773 (1995); and WO 1989/10977, each of which is incorporated herein by reference in its entirety.

In SBS, extension of a nucleic acid primer along a nucleic acid template is monitored to determine the sequence of nucleotides in the template. The underlying chemical process can be catalyzed by a polymerase, wherein fluorescently labeled nucleotides are added to a primer (thereby extending the primer) in a template dependent fashion such that detection of the order and type of nucleotides added to the primer can be used to determine the sequence of the template. In embodiments, sequencing includes annealing and extending a sequencing primer to incorporate a detectable label that indicates the identity of a nucleotide in the target polynucleotide, detecting the detectable label, and repeating the extending and detecting of steps. In embodiments, the methods include sequencing one or more bases of a target nucleic acid by extending a sequencing primer hybridized to a target nucleic acid (e.g., an amplification product produced by the amplification methods described herein). In embodiments, sequencing may be accomplished by a sequencing-by-synthesis (SBS) process. In embodiments, sequencing includes a sequencing by synthesis process, where individual nucleotides are identified iteratively, as they are polymerized to form a growing complementary strand. In embodiments, nucleotides added to a growing complementary strand include both a label and a reversible chain terminator that prevents further extension, such that the nucleotide may be identified by the label before removing the terminator to add and identify a further nucleotide. Such reversible chain terminators include removable 3′ blocking groups such as blocking groups containing azide, disulfide, or allyl moieties, for example as described in U.S. Pat. Nos. 7,541,444, 7,057,026, 10,738,072, 11,174,281, and 11,878,993, each of which are incorporated by reference herein. Once such a modified nucleotide has been incorporated into the growing polynucleotide chain complementary to the region of the template being sequenced, there is no free 3′-OH group available to direct further sequence extension and therefore the polymerase cannot add further nucleotides. Once the identity of the base incorporated into the growing chain has been determined, the 3′ reversible terminator may be removed to allow addition of the next successive nucleotide. By ordering the products derived using these modified nucleotides it is possible to deduce the DNA sequence of the oligonucleotide target nucleic acid sequence.

In embodiments, sequencing includes a plurality of sequencing cycles. In embodiments, sequencing includes 20 to 100 sequencing cycles. In embodiments, sequencing includes 50 to 100 sequencing cycles. In embodiments, sequencing includes 50 to 300 sequencing cycles. In embodiments, sequencing includes 50 to 150 sequencing cycles. In embodiments, sequencing includes at least 10, 20, 30 40, or 50 sequencing cycles. In embodiments, sequencing includes at least 10 sequencing cycles. In embodiments, sequencing includes 10 to 20 sequencing cycles. In embodiments, sequencing includes 10, 11, 12, 13, 14, or 15 sequencing cycles. In embodiments, sequencing includes (a) extending a sequencing primer by incorporating a labeled nucleotide, or labeled nucleotide analogue and (b) detecting the label to generate a signal for each incorporated nucleotide or nucleotide analogue.

In embodiments, sequencing includes sequentially extending a plurality of sequencing primers (e.g., sequencing a first region of a target nucleic acid followed by sequencing a second region of a target nucleic acid, followed by sequencing N regions, where N is the number of sequencing primers in the known sequencing primer set). In embodiments, sequencing includes generating a plurality of sequencing reads.

In embodiments, the neural networks are designed by the modification of neural networks such as AlexNet, VGGNet, GoogLeNet, Graph Convolutional Network, ResNet (residual networks), DenseNet, and Inception networks. In some examples, the enhanced neural networks are designed by modification of ResNet (e.g. ResNet 18, ResNet 34, ResNet 50, ResNet 101, and ResNet 152) or inception networks. In embodiments, the algorithms can use artificial intelligence, such as one or more machine learning algorithms. In embodiments, the machine learning model (e.g., a metamodel) may be trained by using a learning model and applying learning algorithms (e.g., machine learning algorithms) on a training dataset. In embodiments, a machine learning model may be the actual trained model that is generated based on the training model.

Non-limiting examples of machine learning algorithms for training a machine learning model may include supervised learning, unsupervised learning, semi-supervised learning, reinforcement learning, self-learning (also referred to as self-supervised learning), feature learning, anomaly detection, association rules, etc. In some examples, a machine learning model may be trained by using one or more learning models on such training dataset. Non-limiting examples of learning models may include artificial neural networks (e.g., convolutional neural networks, U-net architecture neural network, etc.), backpropagation, boosting, decision trees, support vector machines, regression analysis, Bayesian networks, genetic algorithms, kernel estimators, conditional random field, random forest, ensembles of machine learning models, minimum complexity machines (MCM), probably approximately correct learning (PACT), etc.

In another aspect is provided a method of analyzing a solid support including a plurality of features, the method including obtaining an image of the solid support using a detection apparatus, wherein the solid support includes a first feature including a fluorescent emission and a second feature including a second fluorescent emission; providing the image or image-related data to a computer, wherein the computer includes parameter data of the solid support, including a grid geometry and a feature layout; executing the following on the computer: applying an intensity threshold function to the image or image-related data to provide a masked image; fitting the masked image to a corrugation function; detecting features from the image; and building a computational model of the solid support incorporating the detected features and the parameter data.

In embodiments, the method includes obtaining an image of the solid support using a detection apparatus, wherein the solid support includes a first feature including a fluorescent emission and a second feature including a second fluorescent emission; providing the image or image-related data to a computer, wherein the computer includes parameter data of the solid support; executing the following on the computer: applying an intensity threshold function to the image or image-related data to provide a masked image; fitting the masked image to a corrugation function; detecting features from the image; assigning an index address to each detected feature; and quantifying a signal level for each detected feature.

### III. Systems and Devices

In an aspect is provided a system for analyzing a biological sample (e.g., cells, tissues, or biomolecules such as nucleic acid molecules). In embodiments, the system includes a non-transitory computer-readable medium storing instructions that, when executed by a processor, perform a method for analyzing a biological sample, the method including a method as described herein. For example, the method includes obtaining an image of the solid support using a detection apparatus, wherein the solid support comprises a first feature comprising a fluorescent emission and a second feature comprising a second fluorescent emission; providing the image or image-related data to a computer, wherein the computer comprises parameter data of the solid support; executing the following on the computer: applying an intensity threshold function to the image or image-related data to provide a masked image; fitting the masked image to a corrugation function (e.g., as described herein); and detecting features from the image.

In embodiments, the non-transitory computer-readable medium is a computing device. In embodiments, the computing device is a personal computer system, server computer system, hand-held or laptop device, multiprocessor system, microprocessor-based system, set top box, programmable consumer electronic, network PC, minicomputer system, mainframe computer system, smartphone, or distributed cloud computing environments that include any of the above systems or devices. The computing device can include one or more processors or processing units, a memory architecture that may include RAM and non-volatile memory. The memory architecture may further include removable/non-removable, volatile/non-volatile computer system storage media. Further, the memory architecture may include one or more readers for reading from and writing to a non-removable, non-volatile magnetic media, such as a hard drive, a magnetic disk drive for reading from and writing to a removable, non-volatile magnetic disk, and/or an optical disk drive for reading from or writing to a removable, non-volatile optical disk such as a CD-ROM or DVD-ROM.

In embodiments, the system includes one or more processing units CPU(s) (also referred to as processors), one or more network interfaces, a user interface including a display and an input module, a non-persistent, a persistent memory, and one or more communication buses for interconnecting these components. The one or more communication buses optionally include circuitry (sometimes called a chipset) that interconnects and controls communications between system components. The non-persistent memory typically includes high-speed random access memory, such as DRAM, SRAM, DDR RAM, ROM, EEPROM, flash memory, whereas the persistent memory typically includes CD-ROM, digital versatile disks (DVD) or other optical storage, magnetic cassettes, magnetic tape, magnetic disk storage or other magnetic storage devices, magnetic disk storage devices, optical disk storage devices, flash memory devices, or other non-volatile solid state storage devices. The persistent memory optionally includes one or more storage devices remotely located from the CPU(s). The persistent memory, and the non-volatile memory device(s) within the non-persistent memory, comprise non-transitory computer readable storage medium. In embodiments, one or more of the above identified elements are stored in one or more of the previously mentioned memory devices, and correspond to a set of instructions for performing a function described above. The above identified modules, data, or programs (e.g., sets of instructions) need not be implemented as separate software programs, procedures, datasets, or modules, and thus various subsets of these modules and data may be combined or otherwise re-arranged in various implementations.

In embodiments, the computing device includes memory in electronic communication with the processor. The memory architecture may include at least one program module implemented as executable instructions that are configured to carry out one or more steps of a method set forth herein. For example, executable instructions may include an operating system, one or more application programs, other program modules, and program data. Generally, program modules may include routines, programs, objects, components, logic, and data structures that perform particular tasks. A computing device can optionally communicate with one or more external devices such as a keyboard, a pointing device (e.g., a mouse), a display, such as a graphical user interface (GUI), or other device that facilitates interaction of a use with the unmanned autonomous vehicle. Similarly, the computing device can communicate with other devices (e.g., via network card, modem, etc.). Such communication can occur via I/O interfaces. In embodiments, the computing system may communicate with one or more networks such as a local area network (LAN), a general wide area network (WAN), and/or a public network (e.g., the Internet) via a suitable network adapter.

In embodiments, the systems and devices generate data that may be used to form an image. In embodiments, the image includes a 2D or 3D representation of the tissue. In some embodiments, one or more of the images include an image of other analytes, such as proteins in a biological sample. In some embodiments, an image is acquired using transmission light microscopy (e.g., bright field transmission light microscopy, dark field transmission light microscopy, oblique illumination transmission light microscopy, dispersion staining transmission light microscopy, phase contrast transmission light microscopy, differential interference contrast transmission light microscopy, emission imaging, etc.). In embodiments, the image is in any file format including but not limited to JPEG/JFIF, TIFF, Exif, PDF, EPS, GIF, BMP, PNG, PPM, PGM, PBM, PNM, WebP, HDR raster formats, HEIF, BAT, BPG, DEEP, DRW, ECW, FITS, FLIF, ICO, ILBM, IMG, PAM, PCX, PGF, JPEG XR, Layered Image File Format, PLBM, SGI, SID, CDS, CPT, PSD, PSP, XCF, PDN, CGM, SVG, PostScript, PCT, WMF, EMF, SWF, XAML, and/or RAW. In embodiments, the image is represented as an array (e.g., matrix) comprising a plurality of pixels, such that the location of each respective pixel in the plurality of pixels in the array (e.g., matrix) corresponds to its original location in the image. In some embodiments, an image is represented as a vector comprising a plurality of pixels, such that each respective pixel in the plurality of pixels in the vector comprises spatial information corresponding to its original location in the image.

In embodiments, a pixel includes one or more pixel values (e.g., intensity value). In embodiments, each respective pixel in the plurality of pixels includes one pixel intensity value, such that the plurality of pixels represents a single-channel image comprising a one-dimensional integer vector comprising the respective pixel values for each respective pixel. For example, an 8-bit single-channel image (e.g., grey-scale) can include 2⁸ or 256 different pixel values (e.g., 0-255). In embodiments, each respective pixel in the plurality of pixels of an image includes a plurality of pixel values, such that the plurality of pixels represents a multi-channel image comprising a multi-dimensional integer vector, where each vector element represents a plurality of pixel values for each respective pixel. For example, a 24-bit 3-channel image (e.g., RGB color) can include 2²⁴ (e.g., 2^{8×3}) different pixel values, where each vector element comprises 3 components, each between 0-255. In some embodiments, an n-bit image includes up to 2ⁿ different pixel values, where n is any positive integer.

In embodiments, each pixel in the plurality of pixels of the image has a pixel size (resolution) between 0.8 pm and 4.0 pm. In embodiments the pixel size is derived by dividing the camera pixel size (resolution) by the magnification of the objective lens of the camera used to capture values for the plurality of pixels. In embodiments, each pixel in the plurality of pixels has a pixel size between 0.4 pm and 5.0 pm. In embodiments, each pixel in the plurality of pixels of the image has a pixel size (resolution) between 0.8 pm and 4.0 pm or between 0.4 pm and 5.0 pm.

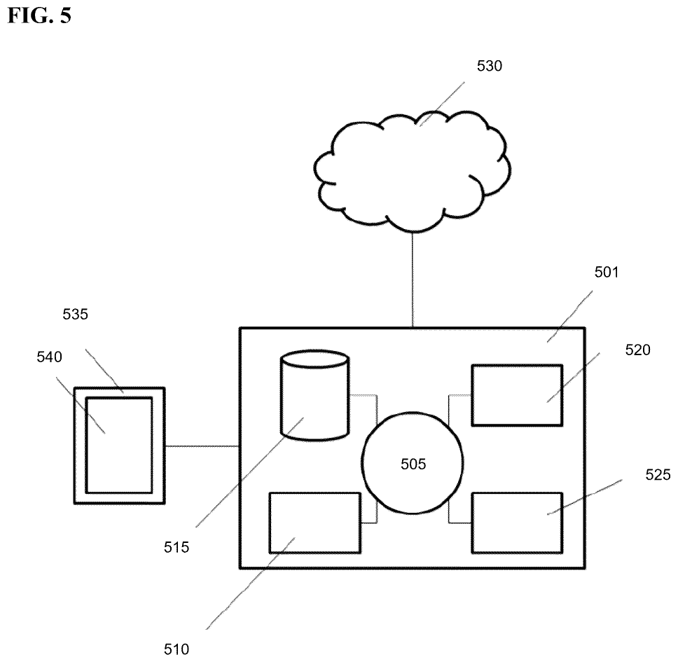

FIG. 5 shows an example computer system that can implement methods provided herein. For example, the present disclosure provides computer systems that are programmed to implement methods of the disclosure. FIG. 5 shows a computer system 501 that is programmed or otherwise configured to analyze a tissue sample including a plurality of cells. The computer system 501 can regulate various aspects of components of the system of the present disclosure. The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet. The computer system 501 can communicate with one or more remote computer systems through the network 530. For instance, the computer system 501 can communicate with a remote computer system of a user. Examples of remote computer systems include personal computers (e.g., portable PC), slates, or tablets (e.g., Apple® iPad, Samsung® Galaxy Tab), telephones, Smart phones (e.g., Apple® iphone, Android-enabled device, Blackberry®), or personal digital assistants. The user can access the computer system 501 via the network 530.

The computer system 501 can communicate with one or more remote computer systems through the network 530. For instance, the computer system 501 can communicate with a remote computer system of a user. Examples of remote computer systems include personal computers (e.g., portable PC), slates, or tablets (e.g., Apple® iPad, Samsung® Galaxy Tab), telephones, Smart phones (e.g., Apple® iphone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre compiled or as-compiled fashion.

Examples of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk.

“Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media (e.g., computer-readable media) include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for tissue sample analysis. Examples of UIs include, without limitation, a graphical user interface (GUI) and web-based user interface. Methods and systems of the present disclosure can be implemented by way of one or more algorithms. An algorithm can be implemented by way of software upon execution by the central processing unit 505.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre compiled or as-compiled fashion.

Examples of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk.

As another example, the computer storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

According to certain embodiments, the above-described data feeds may be stored in databases such as database servers that store master data as well as logging and trace information. The databases may also provide an API and/or API access (e.g., for open source) to the web server for data interchange based on JSON specifications. According to certain embodiments, the database servers may be optimally designed for storing large amounts of data, responding quickly to incoming requests, having a high availability and historizing master data.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor (e.g., a processor chip, single/multi-processor architectures, sequential (Von Neumann)/parallel architectures, and specialized circuits, etc.), or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

In embodiments, the data processor provides the image for display via a display of the computing device. In embodiments, the image is provided for display via a GUI configured within the display of the computing device. In embodiments, the data processor receives an input identifying one or more modifications and/or one or more image analysis steps based on the provided image. For example, the display of the computing device can include a touchscreen display configured to receive a user input identifying a respective pattern of an image of the biological sample on the displayed image. In embodiments, the GUI can be configured to receive a user provided input identifying the modifications and/or one or more image analysis steps.

### EXAMPLES

### Example 1. Algorithm for the Alignment and Registration of Sparse, Uniform Grids

Much of the power of next-generation sequencing (NGS) derives from its extreme throughput and accuracy. DNA molecules are commonly split into fragments and arrayed across the surface of a flow cell. Sequencing (e.g., sequencing by synthesis (SBS)) follows, comprising on the order of one hundred cycles of polypeptide chain extension alternating with fluorescent imaging. This approach permits sequencing to be parallelized many millions of times over while retaining the redundancy to allow error correction. To maximize the number of fragments that can fit onto a single flow cell, a patterned surface may be used, such that the fragments adhere in a regular grid (e.g., a hexagonal grid).

Such patterned flow cells also have the advantage of permitting efficient processing: once the regular grid is mapped, fragments may be indexed by their location within that grid, rather than the much larger space of all available image pixels, and image analysis can proceed on only those grid locations. Efficiently determining the grid orientation, spacing, and phase is paramount to this approach. For example, with the features arranged on a regular grid, there is no need to detect individual feature locations since the locations (x, y, z) are fixed and known. Analyzing images by decomposing functions and/or signals over time into their constituent frequencies, reveal the periodicities and harmonics inherent within. Although use of a repeating grid lends itself naturally to Fourier analysis, Fourier processing is not without its drawbacks. Primarily, methods utilizing Fourier analysis the technique hinges critically on achieving an adequate signal-to-noise ratio, necessitating that the analyzed image not only maintains a minimum size relative to grid spacing but also ensures sufficient feature occupancy. This latter aspect is particularly pivotal, often requiring the introduction of elements such as focusing beads or the reliance on inherent features like fluorescent DNA fragments. Moreover, the ability of the Fourier grid to precisely adapt to local distortions, such as those stemming from manufacturing defects in flow cells or motion artifacts during imaging, is constrained. This limitation poses a significant challenge in accurately capturing and analyzing these local irregularities. Furthermore, in scenarios where feature occupancy is suboptimal, the reliance on computationally demanding methods, like the creation of maximum projection images to artificially enhance feature visibility, becomes necessary. This approach, while effective in augmenting feature representation, substantially increases the computational burden, complicating the analysis process and potentially impacting efficiency. Overall, these factors underscore the complexities and limitations inherent in Fourier analysis within imaging contexts, highlighting areas where careful consideration and potential methodological adaptations are essential.

Herein is described an alternative approach to grid mapping features based on the Lomb-Scargle periodogram, typically used in addressing astronomical observations. Replacing computationally intensive techniques, such as Fourier analysis, with this brand of periodogram analysis relaxes the image size and feature occupancy constraints, allowing grid mapping to be performed on smaller, lower-density images. Described herein are demonstrations of an algorithm based on this method, and show that it produces accurate results even at very low grid occupancies and in the presence of notable local grid distortions. Additionally, this approach can also find use as a diagnostic tool for detecting notable local grid distortions.

The traditional implementation of the Fourier Transform, often referred to as the Discrete Fourier Transform (DFT), has a computational complexity of O(N²), where N is the number of data points. The Fast Fourier Transform (FFT), a common implementation of a Fourier Transform (FT), offers a computational complexity of O(N log N), where N represents the number of data points. This efficiency stems from its divide-and-conquer approach, making FFT particularly suitable for large datasets with evenly spaced data. However, the FT requires evenly spaced data for accurate frequency analysis, often necessitating pre-processing steps like padding or interpolation for unevenly spaced data, which can add to the computational burden. Conversely, the Lomb-Scargle Periodogram, tailored for unevenly spaced data, typically exhibits a higher computational complexity of approximately O(N²), primarily due to the necessity of evaluating the periodogram at numerous frequency points. This makes the basic implementation of LSP more computationally intensive than FFT. However, advancements in LSP algorithms, such as the Fast Lomb-Scargle method, have achieved complexities closer to O(N log N), significantly reducing the computational load for large datasets. The inherent design of LSP to accommodate unevenly spaced data without the need for extensive pre-processing gives it a distinct advantage in handling raw datasets, particularly in fields like astronomy and geophysics where data irregularity is common.

Whereas calculating the Fourier transform of a dataset requires equally-spaced time or frequency points, the Lomb-Scargle periodogram attempts to calculate the most likely signal spectrum based on whatever data points are available. This approach has been used in astronomy, for instance, to deal with the night sky only being optimally visible at certain intervals. It has been furthermore shown that the relevant equations are equivalent to performing a least-squares fit of the data to a sinusoidal model with a varying frequency; while this is most commonly performed on one-dimensional signals, it generalizes readily to the analysis of two-dimensional images.

The feature extraction algorithm begins (1) obtaining an image that includes a plurality of bright features that fall on the vertices of a heretofore-unknown grid (e.g. a hexagonal grid). This could be an initial image obtained with reflective or fluorescent particles randomly ordered on a surface, for instance. For example, particles referred to as “focusing beads” may be located randomly, i.e., not adhering to a pattern grid, and may therefore be a source of noise for the pattern detection algorithm. Alternatively, the focusing beads may be located according to a pattern (e.g., a grid). Occasionally, the focusing beads are brighter than amplification clusters. In order to improve the signal-to-noise ratio (SNR) of the pattern, the focusing bead images may be altered before running pattern detection. The focusing beads detected in the altered image (referred to as an alt image), and a binary map of their location is stored. (2) If necessary, subdivide the original image into smaller regions of interest (ROIs) and apply the algorithm to each ROI separately in order to obtain the desired level of granularity. As an example, each ROI might measure twenty periods of the grid (e.g. a hexagonal grid) in each dimension. (3) Use an intensity threshold to mask out the regions containing no features. This step essentially reinterprets the original, possibly sparse, image as a dense one that has simply been sparsely and non-uniformly sampled. (4) Fit the masked image to the following corrugation function using any standard curve-fitting routine. The corrugation function, (G(x)), for a symmetric hexagonal grid, is as follows:

$$G ( \vec{x} ) = \frac{1}{3} cos ( 2 π \vec{{k}_{1}} \cdot \vec{x} + {ϕ}_{y} ) + \frac{1}{3} cos ( 2 π \vec{{k}_{2}} \cdot \vec{x} + {ϕ}_{x} + \frac{1}{2} {ϕ}_{y} ) + \frac{1}{3} cos ( 2 π \vec{{k}_{3}} \cdot \vec{x} - {ϕ}_{x} + \frac{1}{2} {ϕ}_{y} )$$

$$\vec{{k}_{1}} = {k}_{0} [ \begin{matrix}0 \\ 1\end{matrix} ] , \vec{{k}_{2}} = {k}_{0} [ \begin{matrix}\sqrt{3} / 2 \\ 1 / 2\end{matrix} ] , \vec{{k}_{3}} = {k}_{0} [ \begin{matrix}- \sqrt{3} / 2 \\ 1 / 2\end{matrix} ]$$

$$\vec{x} = [ \begin{matrix}x \\ y\end{matrix} ] , {k}_{0} = \frac{2}{\sqrt{3}} \frac{1}{{Λ}_{patt}}$$

where ϕₓ and ϕ_{y} are fit parameters that translate the grid and Λₚₐₜₜ is the pitch of the grid. The masked pixels may be omitted from this fit, neither contributing to nor penalizing the fit quality.

Applying standard trigonometric identities to the above corrugation function allows it to be cast into a form that is easier for machines to evaluate. The above equation can be recast into either of two more computationally efficient forms using standard trigonometric identities. For example, in the first form:

$$G ( \vec{x} ) = \frac{1}{3} cos ( 2 π \vec{{k}_{1}} \cdot \vec{x} ) cos ( {ϕ}_{y} ) - \frac{1}{3} sin ( 2 π \vec{{k}_{1}} \cdot \vec{x} ) sin ( {ϕ}_{y} ) + \frac{1}{3} cos ( 2 π \vec{{k}_{2}} \cdot \vec{x} ) cos ( {ϕ}_{x} + \frac{1}{2} {ϕ}_{y} ) - \frac{1}{3} sin ( 2 π \vec{{k}_{2}} \cdot \vec{x} ) sin ( {ϕ}_{x} + \frac{1}{2} {ϕ}_{y} ) + \frac{1}{3} cos ( 2 π \vec{{k}_{3}} \cdot \vec{x} ) cos ( - {ϕ}_{x} + \frac{1}{2} {ϕ}_{y} ) - \frac{1}{3} sin ( 2 π \vec{{k}_{3}} \cdot \vec{x} ) sin ( - {ϕ}_{x} + \frac{1}{2} {ϕ}_{y} )$$

The coefficients that do not include ϕₓ or ϕ_{y} are static for a given grid, and can be pre-computed. The optimization problem then becomes one of finding the best values of

$$cos ( {ϕ}_{y} ) , sin ( {ϕ}_{y} ) , cos ( {ϕ}_{x} + \frac{1}{2} {ϕ}_{y} ) , sin ( {ϕ}_{x} + \frac{1}{2} {ϕ}_{y} ) , cos ( - {ϕ}_{x} + \frac{1}{2} {ϕ}_{y} ) ,$$

and

$$sin ( - {ϕ}_{x} + \frac{1}{2} {ϕ}_{y} ) ,$$

subject to the constraints implied by those forms. This is a constrained linear optimization problem, and can be solved efficiently by any of several established methods. The values of ϕₓ or ϕ_{y} can be extracted at the end using inverse trigonometric functions, avoiding computationally expensive trigonometric evaluations during the actual fit.

In another form, obtained by further simplification of the first form:

$$G ( \vec{x} ) = \frac{1}{3} cos ( 2 π \vec{{k}_{1}} \cdot \vec{x} ) cos ( {ϕ}_{y} ) - \frac{1}{3} sin ( 2 π \vec{{k}_{1}} \cdot \vec{x} ) sin ( {ϕ}_{y} ) + \frac{1}{3} cos ( 2 π \vec{{k}_{2}} \cdot \vec{x} ) [ {cos ( ϕ )}_{x} cos ( \frac{1}{2} {ϕ}_{y} ) - sin ( {ϕ}_{x} ) sin ( \frac{1}{2} {ϕ}_{y} ) ] - \frac{1}{3} sin ( 2 π \vec{{k}_{2}} \cdot \vec{x} ) [ sin ( {ϕ}_{x} ) cos ( \frac{1}{2} {ϕ}_{y} ) + cos ( {θ}_{x} ) sin ( \frac{1}{2} {ϕ}_{y} ) ] + \frac{1}{3} cos ( 2 π \vec{{k}_{3}} \cdot \vec{x} ) [ cos ( {ϕ}_{x} ) cos ( \frac{1}{2} {ϕ}_{y} ) + sin ( {ϕ}_{x} ) sin ( \frac{1}{2} {ϕ}_{y} ) ] + \frac{1}{3} sin ( 2 π \vec{{k}_{3}} \cdot \vec{x} ) [ sin ( {ϕ}_{x} ) cos ( \frac{1}{2} {ϕ}_{y} ) - cos ( {ϕ}_{x} ) sin ( \frac{1}{2} {ϕ}_{y} ) ]$$

Once more, the coefficients that do not include ϕₓ or ϕ_{y} can be pre-computed, and the fit can be performed on the basis of cos(ϕ_{y}), sin(ϕ_{y}), sin(ϕₓ), sin(ϕₓ),

$$cos ( \frac{1}{2} {ϕ}_{y} ) ,$$

and

$$sin ( \frac{1}{2} {ϕ}_{y} ) ,$$

again without needing to perform expensive trigonometric evaluations beyond the initial pre-computation and the final extraction of ϕₓ and ϕ_{y}.

Relative to the first form, this second form simplifies the fit constraints in exchange for introducing nonlinearity into the fit itself. Which of these forms is ultimately preferred will depend on the algorithmic implementation. Analogous recastings can be performed for other corrugation functions.

The corrugation function for a general hexagonal grid (rotated, skewed, and/or isotropic), is provided as:

$$G ( \vec{x} ) = \frac{1}{3} cos ( 2 π \vec{{k}_{1}} \cdot \vec{x} + {ϕ}_{y} ) + \frac{1}{3} cos ( 2 π \vec{{k}_{2}} \cdot \vec{x} + {ϕ}_{x} + \frac{1}{2} {ϕ}_{y} ) + \frac{1}{3} cos ( 2 π \vec{{k}_{3}} \cdot \vec{x} - {ϕ}_{x} + \frac{1}{2} {ϕ}_{y} )$$

$$\vec{{k}_{1}} = {k}_{0} [ \begin{matrix}- sin θ \\ cos θ\end{matrix} ] , \vec{{k}_{2}} = {k}_{0} [ \begin{matrix}( \sqrt{3} / 2 ) cos θ - ( 1 / 2 ) sin θ \\ ( \sqrt{3} / 2 ) sin θ + ( 1 / 2 ) cos θ\end{matrix} ] , \\ \vec{{k}_{3}} = {k}_{0} [ \begin{matrix}- ( \sqrt{3} / 2 ) cos θ - ( 1 / 2 ) sin θ \\ - ( \sqrt{3} / 2 ) sin θ + ( 1 / 2 ) cos θ\end{matrix} ]$$

$$\vec{x} = [ \begin{matrix}α x \\ β y\end{matrix} ] , {k}_{0} = \frac{2}{\sqrt{3}} \frac{1}{{Λ}_{patt}}$$

where θ is a rotation angle, and α and β are skew factors.

The corrugation function for a rectangular grid (rotated, skewed, and/or isotropic), is provided as:

$$G ( \vec{x} ) = \frac{1}{2} cos ( 2 π \vec{{k}_{i}} \cdot \vec{x} + {ϕ}_{y} ) + \frac{1}{2} cos ( 2 π \vec{{k}_{2}} \cdot \vec{x} + {ϕ}_{x} )$$

$$\vec{{k}_{1}} = \frac{1}{{Λ}_{1}} [ \begin{matrix}0 \\ 1\end{matrix} ] , \vec{{k}_{2}} = \frac{1}{{Λ}_{2}} [ \begin{matrix}1 \\ 0\end{matrix} ]$$

One skilled in the art could readily apply rotation/skew matrices as

appropriate.

In the realm of data analysis, three widely used curve-fitting routines are commonly used: Linear Regression, Polynomial Regression, and Nonlinear Least Squares. Linear Regression is perhaps the most fundamental and widely used method, ideal for scenarios where the relationship between the independent and dependent variables is expected to be linear. This technique minimizes the sum of the squares of the differences between the observed values and those predicted by the linear model, yielding a line of best fit. Polynomial Regression extends linear regression by allowing for higher-order polynomials in the model, making it suitable for more complex relationships that exhibit curvature. This method can fit a wide range of curves, from simple quadratics to higher-degree polynomials, depending on the nature of the data and the degree of the polynomial used. Nonlinear Least Squares is employed when the relationship between variables is inherently nonlinear and cannot be suitably described by polynomials. This technique iteratively adjusts the parameters of a nonlinear model to minimize the sum of squares of the residuals, fitting curves to data where linear or polynomial models are inadequate.

An additional step may be considered for the algorithm, i.e., step (5), if the fitted vertex locations themselves are required, they can be calculated as the points where each of the cosine terms in the corrugation function is independently and simultaneously equal to unity. In some cases, this step will not be necessary, as the translation relative to an ideal grid given by ϕₓ and ϕ_{y} is all that is needed.

The mask in step (3) may use an arbitrarily-chosen constant intensity threshold; an adaptive threshold based on the brightness statistics of the image; or a threshold that varies piecewise by the statistics of each neighborhood of the image. An advantage of this algorithm is that clipping the edges of important features by setting the threshold too high has only a minor impact on the results, as the masked data is ignored completely by the corrugation fit. This stands in contrast to commonly employed image analysis algorithms where such clipping may be tantamount to affirming that the clipped pixels were zero rather than simply omitted, in effect introducing erroneous data. In the examples shown here (e.g., described in Example 2), a threshold of twice the median pixel value (i.e., approximately twice the average background level) was used.

The function given step (4) may be modified ad hoc. For instance, a rectangular corrugation may be used if the expected grid is rectangular rather than hexagonal, or more complex functions if a repeating but non-isotropic grid is desired. In addition, the fit may include varying other parameters, including the overall amplitude; the overall rotation; the asymmetry/skew; or the corrugation period. In addition, realistic constraints may be placed on the fit parameters, including restricting the translations, amplitude, rotation, skew, and/or grid pitch based on physical assumptions of the imaging system and sample. As an example, rotation or skew might be introduced by applying a standard rotation matrix to \vec{k₁}, \vec{k₂}, and/or \vec{k₃} and allowing the rotation angle to vary.

The least-squares fit in step 4 may be performed with randomly initialized parameters. To avoid erroneous local minima, it may be repeated one or more times using different random instantiations. Alternatively, it may be initialized using values of ϕₓ and ϕ_{y} that cause a local maximum of the function to coincide with the calculated argmax of the image.

The implicit definitions of ϕₓ and ϕ_{y} in the corrugation function shown above result in them being proportional to the pixel translations of the grid, with the proportionality constant determined by the grid pitch and the geometry of the grid. Those proportionality constants may be absorbed into the definitions of ϕₓ and ϕ_{y} via a different definition of the corrugation function without fundamentally changing the algorithm.

For finalized sequencing images, the initial focusing bead map may aligned to the sequencing image, and the pixels belonging to the focusing beads are “in-painted”, i.e. focusing beads are erased and their pixels are filled with values interpolated from their immediate surroundings.

### Example 2. Performance and Limitation Testing

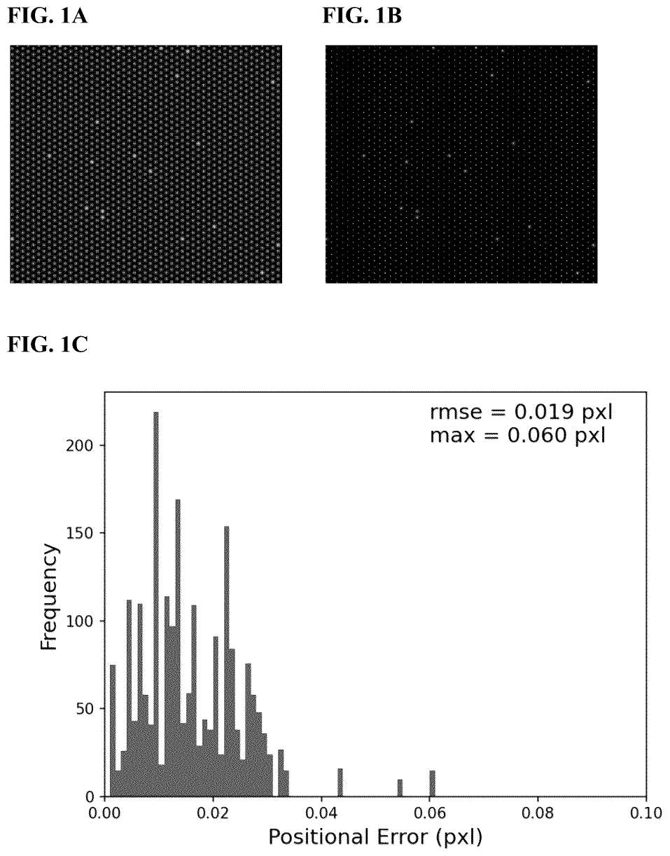

To demonstrate this algorithm, an initial implementation was coded and deployed on a series of simulated images. By adjusting the simulation parameters (grid pitch, feature occupancy, feature signal-to-noise ratio, grid distortions, etc.), the robustness of the algorithm was evaluated in the presence of various realistic challenges. In one representative example (FIGS. 1A-1C), a hexagonal grid of Gaussian features (2.0-pixel full-width-half-maximum), a pitch of 4.48 pixels, and an occupancy fraction of 1% was created. The peak intensity of each feature was 500 counts, and Poissonian noise with an average value of 50 counts was added to each pixel to mimic realistic noise encountered in sequencing images. The image was divided into non-overlapping ROIs of dimension 200×200 pixels, and the grid mapping algorithm was applied. Because the original images were simulated, the exact feature locations (i.e., truth locations) were known and could be compared to those of the corresponding, fitted, grid vertices (i.e., computed locations). As can be seen in FIGS. 1A-1C, the bulk of the mapped locations were within 0.03 pixels of the simulated locations, demonstrating the fidelity of the approach. Tests performed on grids that had been deliberately distorted by a known amount produced similar results, provided the distortion was slowly-varying compared to the chosen ROI size.

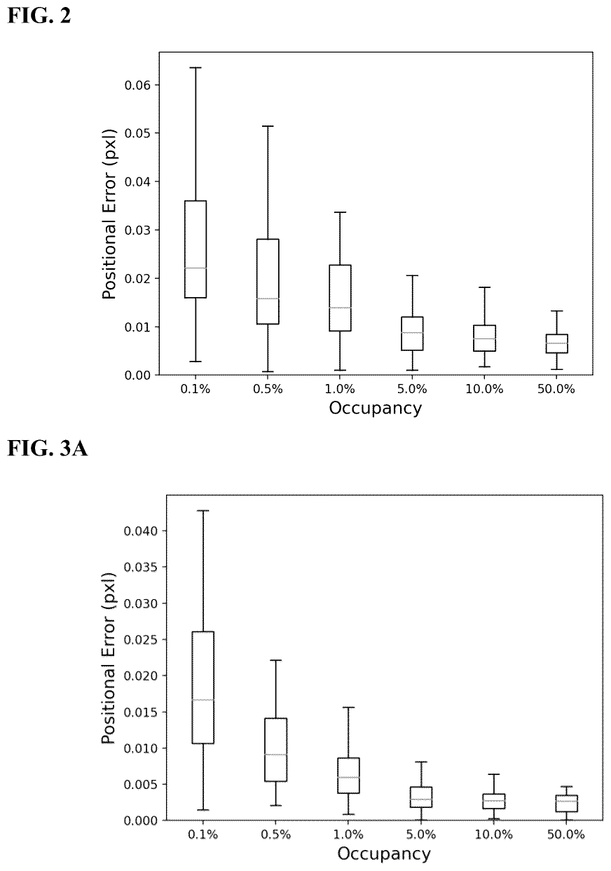

The robustness of the implemented algorithm to image sparsity (i.e., low density features) was tested by simulating images with different occupancy fractions and performing similar tests. The resulting positional error distributions are shown in FIG. 2. As a point of reference, an occupancy fraction of 1% corresponded to an average of 25 features per 200×200 ROI. As the occupancy decreased, the positional error increased, but remained well below 0.1 pixels even at 0.1% occupancy. This is well below the typical feature density of focusing beads typically introduced in NGS applications, and orders of magnitude below that of the DNA fragments themselves, confirming the suitability of the approach for analyzing such sparse images.

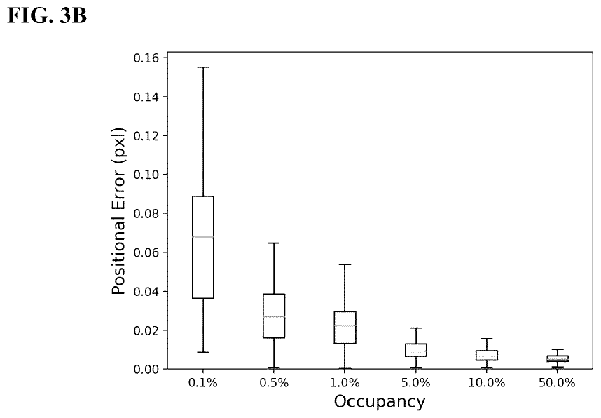

Also of interest is the algorithm's performance when faced with grids of different pitches. FIGS. 3A-3B illustrates the results for a grids of pitches 3.2 pixels (FIG. 3A) and 2.24 pixels (FIG. 3B). Both used the same, 200×200 ROI size, making 1% occupancy fraction correspond to an average of 50 features/ROI and 100 features/ROI, respectively. The 3.2-pixel grid performs comparably to the 4.48-pixel grid; the 2.24-pixel grid results in a larger amount of error, likely because the hexagonal grid is beginning to violate the Nyquist sampling theorem along one axis, but overall still produces reasonable results at moderate occupancy fractions.

### Example 3. Performance as a Device Diagnostic

Another application of this algorithm is in the detection and quantification of imaging artifacts and aberrations such as lateral vibrations. For example, in a linescanning or time-delay integration (TDI) imaging system, where images are acquired synchronously with a continuous, lateral scan, vibrations transverse to the optic axis might appear as local shifts in the image, turning straight lines into wavy ones. Such vibrations might be the result of nearby machinery, fans, or imperfections in the imaging scanning apparatus of the device, for instance. When imaging a grid of features, as in the previously discussed applications, artifacts of this nature have the ability to disrupt the uniformity of the grid and thereby impede gridmapping and subsequent image analysis. The ability to measure and quantify such effects from a thusly-affected image is of great value in identifying and reducing them.

Adapting the algorithm to the task of measuring transverse vibrations can be done using the following approach: (1) Split the target image into a grid of ROIs as previously described in Examples 1 and 2. (2) For each ROI, mask the low-intensity regions and fit the masked images to a corrugation function as previously described. (3) Record the fitted phases for each ROI as a map of local phase shifts. And (4) Using unwrapping techniques, unwrap the phase shift map into a map of local translations. The result of the is a map of local translations relative to an idealized grid (exemplified by the corrugation fit function). Standard digital signal processing tools such as Fourier analysis, spectrogram analysis, or wavelet analysis can further be applied to analyze and interpret this map.

In embodiments, types of unwrapping techniques commonly utilized in the context of phase shift maps include Quality-Guided Unwrapping (QGU), which prioritizes the unwrapping sequence based on the quality of the phase information. Branch-Cut Unwrapping (BCU), which involves placing branch cuts, which are artificial barriers, between regions of rapid phase change (discontinuities), and Minimum-Norm Unwrapping (MNU), which minimizes the norm of the gradient of the unwrapped phase to achieve the smoothest phase map possible. QGU begins unwrapping at the highest quality points and propagates to areas of lower quality, reducing the likelihood of error propagation in regions with rapid phase changes or noise, relying on the variance or gradient of the phase. When utilizing BGU the cuts prevent the unwrapping path from crossing areas where phase jumps are significant, thus avoiding the introduction of errors. Unwrapping proceeds along paths circumventing these branch cuts, ensuring accurate reconstruction of the phase information. MNU solves a minimization problem to find the most probable distribution of phase values across the map, making it effective in dealing with noise and discontinuities in the phase data. The phase difference image may be passed to a 2D phase unwrapping routine. Areas with low absolute correlations are masked from unwrapping. Spuriously high correlations sometimes arise from noise, such as in the side areas that are outside of the lane and have no pattern. Such high correlation islands are typically small, disconnected from the lane, or connected to it via thin isthmuses. Binary morphological opening on the mask is performed to get rid of the improbable small high-correlation artifacts. Correlation values as low as 0.02 or slightly less are sufficient to produce good unwrapping results.

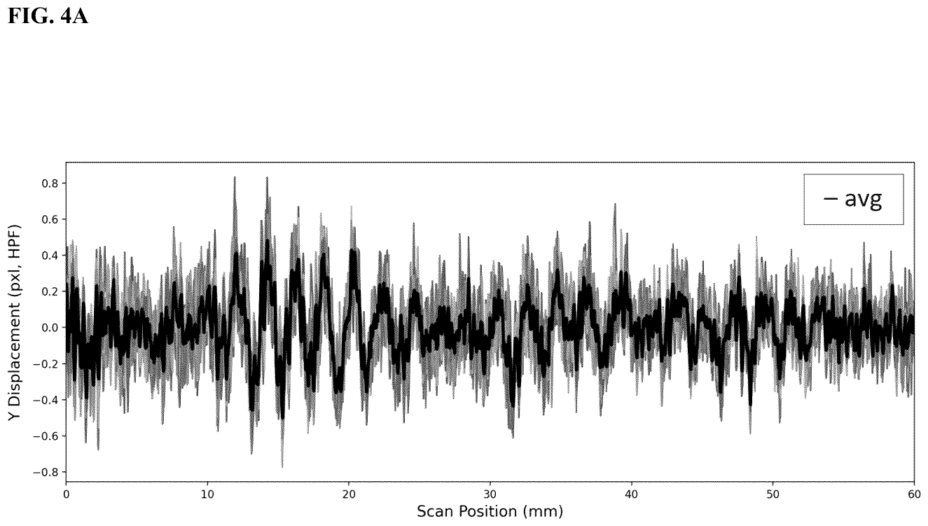

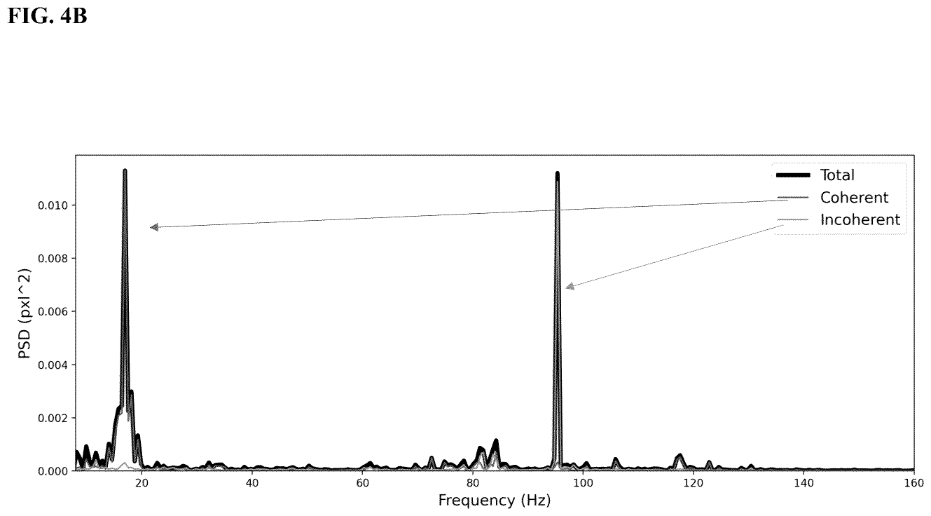

This approach has been demonstrated in a system suffering from two major vibrational sources: a physical imperfection in the scanning stage causing a repeatable, 16-Hz oscillation, and an unbalanced fan operating near 95 Hz mounted on the imaging system. Both of these sources resulted in oscillations perpendicular to both the optic axis and the scanning axis, with the oscillation direction defined here as the Y-axis. A fluorescent sample comprising a uniform hexagonal grid of small features, similar to that described above, was imaged using a time-delay integration modality to produce a 60 mm×1.7 mm image. In this example, image acquisition was repeated eleven times in order to determine the repeatability of both the vibrations and the measurement method; however, the latter being thusly proven, if the former is not a concern, only a single acquisition is required to provide a snapshot of the oscillations. FIGS. 4A-4B depicts the results of this analysis. FIG. 4A shows the local displacement as a function of scan position; the thinner, lines represent individual images, while the thick, black one is the average. A high-pass filter with a cut-off frequency of several Hertz has been applied here to isolate the oscillations of interest. FIG. 5B shows the power spectrum of the data as calculated via the Fast Fourier Transform (FFT). The black trace (labeled “total”) is the sum of the power spectra of the individual acquisitions; the trace labeled “coherent” is the power spectrum of the average signal, and therefore shows those vibrations which are repeatable over multiple acquisitions; the trace labeled “incoherent” is the power spectrum of the differences between each individual acquisition and their mean, and therefore shows those vibrations that do not precisely repeat in successive acquisitions. Both of the expected vibrations are clearly observable-the repeatable stage oscillation at 16 Hz, and the random fan oscillation near 95 Hz. The ability to detect and differentiate both coherent and incoherent signals at the sub-pixel level strongly establishes the precision and reliability of the algorithm.

Herein is demonstrated a novel algorithm for mapping sparse images to a known, underlying grid structure. The accuracy is confirmed by testing it on simulated images with varying pitches, densities, and local distortions, and have furthermore reduced it to practice in an experimental setting. The use cases shown are analogous to those that may be encountered during NGS sequencing, establishing the viability of the approach for that application. The described algorithm introduces several features that significantly enhance its utility in grid-based imaging systems. One key innovation is its ability to detect and quantify imaging artifacts, such as transverse vibrations, by analyzing distortions in the feature grid. By splitting the image into regions of interest, applying masking, and fitting the masked regions to a corrugation function, the algorithm generates a phase shift map that is unwrapped into local translations using advanced phase unwrapping techniques. Methods such as Quality-Guided Unwrapping, Branch-Cut Unwrapping, and Minimum-Norm Unwrapping are employed to ensure accurate phase reconstruction, even in noisy or discontinuous regions, with additional correlation-based masking and binary morphological operations to eliminate improbable artifacts. Another novel feature is the integration of digital signal processing tools, including Fourier analysis and spectrogram analysis, to analyze the mapped local translations and distinguish between coherent and incoherent vibrational components with sub-pixel precision. The algorithm's capability to resolve vibrations across multiple frequency domains and its adaptability to sparse or distorted grids further establish its potential for high-resolution imaging applications, such as next-generation sequencing and diagnostic imaging. These features collectively enable precise artifact detection, vibration quantification, and robust grid mapping in challenging imaging scenarios.

### Example Computer System

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

With certain aspects, to provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), the Internet, WiFi (IEEE 802.11 standards), NFC, BLUETOOTH, ZIGBEE, and the like.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed:

1. A method of imaging a solid support comprising a plurality of features, the method comprising:
obtaining an image of the solid support using a detection apparatus, wherein the solid support comprises a first feature comprising a fluorescent emission and a second feature comprising a second fluorescent emission;
providing the image or image-related data to a computer, wherein the computer comprises parameter data of the solid support;
executing the following on the computer:
applying an intensity threshold function to the image or image-related data to provide a masked image;
fitting the masked image to a corrugation function;
detecting features from the image.

2. The method of claim 1, further comprising assigning an index address for each feature; and quantifying a signal level of each feature.

3. The method of claim 1, further comprising obtaining a plurality of images of the solid support.

4. The method of claim 1, further comprising obtaining a series of images of the solid support.

5. The method of claim 1, wherein the solid support comprises a plurality of features.

6. The method claim 2, further comprising building a model of each image incorporating known feature locations the index address for each feature.

7. The method of claim 6, wherein the model comprises a matrix and is stored in computer memory or a computer-readable medium.

8. The method of claim 7, wherein the matrix is reused for a different image.

9. The method of claim 2, wherein each index address is a unique address.

10. The method of claim 9, wherein each unique address is an integer vector of length 2.

11. The method of claim 1, wherein the parameter data relates to
a grid orientation angle;
an apparent pitch in pixel units, and/or
a phase of a feature grid at a fixed pixel location of the image.

12. The method of claim 1, wherein first feature and/or the second corresponds to a discrete plurality of nucleic acid molecules.

13. The method of claim 1, wherein the intensity threshold function comprises an adaptive threshold.

14. The method of claim 1, wherein fitting the masked image to a corrugation function comprises optimizing parameters of the corrugation function.

15. The method of claim 1, further comprising computationally applying corrections to the parameter data of the solid support to account for local distortions, wherein the corrections include adjusting the grid pitch and rotation angle of the corrugation function.

16. The method of claim 1, wherein fitting the masked image to a corrugation function comprises fitting the masked image to a corrugation function configured to model a non-hexagonal grid geometry, including rectangular, triangular, or irregular grid.

17. The method of claim 1, further comprising aligning features detected from the image with features detected from a second image obtained during a subsequent imaging cycle, wherein the alignment is performed using the parameter data of the solid support and the detected features from the image.

18. A computer-implemented method for analyzing electronic images of a biological sample, comprising
obtaining an image of the solid support using a detection apparatus, wherein the solid support comprises a first feature comprising a fluorescent emission and a second feature comprising a second fluorescent emission;
providing an image or image-related data to a computer, wherein the image comprises a plurality of fluorescent features associated with the the biological sample on a solid support, and wherein the computer comprises parameter data of the solid support;
executing the following on the computer:
applying an intensity threshold function to the image or image-related data to provide a masked image;
fitting the masked image to a corrugation function; and
detecting features from the image.

19. A non-transitory computer-readable medium storing instructions that, when executed by a processor, perform a method for analyzing a biological sample, the method comprising
obtaining an image of the solid support using a detection apparatus, wherein the solid support comprises a first feature comprising a fluorescent emission and a second feature comprising a second fluorescent emission;
providing the image or image-related data to a computer, wherein the computer comprises parameter data of the solid support;
executing the following on the computer:
applying an intensity threshold function to the image or image-related data to provide a masked image;
fitting the masked image to a corrugation function;
detecting features from the image.
